(19) United States
(12) Patent Application Publication
(10) Pub. No.: US 2002/0178289 A1
(43) Pub. Date: Nov. 28, 2002

(54) Communications device, address modification device, communications method and communications control program

(76) Inventor: Yoshitoshi Kurose, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/043,744

(22) Filed: Jan. 10, 2002

(30) Foreign Application Priority Data
May 25, 2001 (JP) 2001-157129

(51) Int. Cl. G06F 15/16

(52) U.S. Cl. 709/245

(57) ABSTRACT

On receipt of communications data from a client with an address modified by the relay device, the source address modification unit of a server (communications device) modifies the source address of data in response to the communications data to the source address registered in a source address modification database. Thus, response data can be directly transmitted to the client without going through the relay device and a communications route can be shortened accordingly.

### BACKGROUND OF THE INVENTION

1. Field of the Invention

The present invention relates to a communications device connected to a network, an address modification device, a communications method in a network with the address modification device and the communications control program.

2. Description of the Related Art

Recently, when services to be provided are modified for each user or the load of a server on which communications centers are distributed, an address modification device for modifying both a destination address and a source address in communications is used as a method. Such an address modification device does not require the additional function of a communications terminal and further can freely modify a communication terminal in end-to-end communications by modifying information about both the destination and source addresses. The address modification device can modify both the destination and source addresses of a received communications content and perform control of end-to-end communications for the purposes of service provision for each user, load distribution of a server and the like.

FIG. 1 shows the modification method of an IP address in a communications network where data with an identifier indicating both destination and source addresses are transmitted and received.

A client 12 transmits data to a server (A) 13 ((1) of FIG. 1). The data always includes an IP address.

An address modification device 11 modifies the destination IP address of the data from the server (A) 13 to a server (B) 14 and transfers the data to a new address ((2) of FIG. 1). The address modification device 11 performs control of end-to-end communications by modifying both the destination address of the data received from the client 12 and the source address for a return transmission. Thus, as shown in FIG. 1, the destination IP address A of data are modified to destination IP address B, and the data are transmitted to the server (B) 14.

The server (B) 14 receives the data as a request from the client 12, performs a prescribed process and transmits response data to the client 12 ((3) of FIG. 1).

The address modification device 11 modifies the source IP address of the response data from the server (B) 14 to that of the server (A) 13 and transfers the response data to the client 12 ((4) of FIG. 1). Since the address modification device 11 modifies the source IP address of the response data to that of the server (A) 13 in this way, it looks to the client 12 as if the client 12 were communicating with the server (A) 13. Thus, the server (B) 14 can be used instead of the server (A) 13 without adding a function to hide the physical or logical location of a server to the server (A) 13 or client 12.

However, since in a method using the address modification device 11 described above, both the communications content addressed from the client 12 to the server (A) 13 and the communications content addressed from the server (B) 14 to the client 12 must be modified, the communications must always pass through the address modification device 11.

If the communications from the server (B) 14 does not pass through the address modification device 11 (passes along a route denoted with a dotted line in (5) of FIG. 2), normal communications are not conducted since the client 12 wrongly recognizes that the communications must be from the server (B) 14, which is a problem.

Therefore, the address modification device 11 rewrites the source IP address to the IP address (IP address D) of the corresponding server (B) 14 when modifying the address and transmits the data to the server (B) 14. Thus, the server (B) 14 transmits the response data to the address modification device 11 ((3) of FIG. 2). On receipt of the response data from the server (B) 14, the address modification device 11 modifies both the destination and source addresses of the communications content and transmits the data to the client 12 ((4) of FIG. 2).

However, in the method described above, if servers are scattered over a wide area network, there are the following problems.

Specifically, if both the route between the client 12 and address modification device 11 and the route between the address modification device 11 and server (B) 14 are long, and the route between the client 12 and server (B) 14 is short, the transmission line delay of communications occurs although there is no transmission line delay of communications if the client 12 and server (B) 14 directly communicate, which is a problem. Since in this case, an extra communications route is used, band resources are also wasted, which is another problem.

For example, as shown in FIG. 2, although there is only one router 15 to pass through between the client 12 and server (B) 14, there are six routers 15 along a route through the address modification device 11. Therefore, the transmission line delay proportionally increases and more of the band resources of a network are wasted.

### SUMMARY OF THE INVENTION

It is an object of the present invention to shorten the communications route between communications devices in network communications with an address modification device.

One communications device according to the present invention that is connected to a network with an address modification device comprises a transmitting and receiving unit transmitting and receiving communications data and a source address modification unit restoring the source address of data in response to communications data with an address modified by the address modification device to the original destination address of the response data.

The destination address of communications data transmitted from a communications device 25 to a specific communications device 22 is modified and the data is transferred to the communications device 22.

The source address modification unit 24 of the communications device 22 modifies the source address of data in response to the communications data received by a transmitting and receiving unit 23 to the pre-modification address.

Thus, the response data can be transmitted from the communications device 22 on the receiving side to the communications device on the originating side without passing through the address modification device 21. Therefore, even if the route leading from the communications device 22 to the communications device 25 on the originating side through the address modification device 21 is redundant and long, the response data can be transmitted along the optimal route leading from the communications device 22 on the receiving side to the communications device 22 on the originating side.

Another communications device according to the present invention that is connected to a network with an address modification device comprises a transmitting and receiving unit transmitting and receiving communications data, an acquisition unit obtaining modification information about an address to which the data is transmitted from the address modification device and a source address modification unit modifying the source address of data in response to communications data transferred from the address modification device based on the modification information.

Since according to the present invention, the source address of response data can be modified based on the modification information transmitted from the address modification device, there is no need to store modification information about a source address. Since response data can be transmitted to a communications device on the originating side without going through an address modification device, communications can also conducted along an optimal route.

Another communications device according to the present invention that is connected to a network with an address modification device comprises a transmitting and receiving unit 23 transmitting and receiving communications data, a request unit 26 requesting the address modification device to transmit the address modification information of received communications data and a source address modification unit 24 modifying the source address of data in response to the communications data based on the modification information transmitted from the address modification device.

According to this invention, the communications device 22 requests the address modification device 21 to transmit address modification information and modifies the source address of response data based on the modification information transmitted from the address modification device 21. Since the response data can be transmitted using the communication device with the original address of the response data designated as the source address, the communications device 25 on the originating side can recognize the response data as data in response to transmission data. Therefore, the response data can be transmitted to the communications device 25 on the originating side without going through the address modification device 21 and a communications route can be optimized.

In the invention described above, the source address modification unit can also generate a modification table based on modification information indicating an address before modification and can modify the source address of data in response to communications data based on the modification table.

By adopting such a configuration, the modification table can be generated based on address information transmitted from the address modification device 21. Then, it is judged whether the source address of the response data should be modified, based on the modification table and the source address of the response data can be modified if it is judged that the source address should be modified.

The invention described above can also comprise a plurality of communication processing units and a sorting unit assigning the process of communications data to an optimal communications processing unit of the plurality of communications processing units based on identification information attached to the data.

By adopting such a configuration, an optimal communications processing unit can be used if a communications device has a plurality of communications processing units.

The address modification device of the present invention comprises a transmitting and receiving unit transmitting and receiving communications data, an address modification unit modifying the address of the communications data and an address information generating unit enabling a communications device to transmit the address modification information of the communications data to the communications device with the modified address.

According to this invention, the communications device that receives the transmission data with the address modified by an address modification device, can modify the source address of response data to the original address based on modification information transmitted from the address modification device.

Another address modification device according to the present invention comprises a transmitting and receiving unit transmitting and receiving communications data, an address modification unit modifying the address of the communications data transmitted from a communications device and a modification information generating unit transmitting the address modification information of the communications data to the relevant communications device on receipt of the send request of address modification information.

According to this invention, by transmitting modification information according to the send request for address modification information from a communications device, there is no need to store information about source address modification on the communications device side. Since data can be transmitted after restoring the source address of the data to the pre-modification address, backward communications can be conducted along an optimal communications route without going through a relay device.

### BRIEF DESCRIPTION OF THE DRAWINGS

FIG. 1 shows the modification method of an IP address;

FIG. 2 shows problems;

FIG. 3 shows the basic configuration of one preferred embodiment;

FIG. 4 shows the basic configuration of another preferred embodiment;

FIG. 5 shows the outline of the network of the first preferred embodiment;

FIG. 6 shows the configuration of each device in the first preferred embodiment;

FIG. 7A shows the configuration of a destination address modification database;

FIG. 7B shows the configuration of a source address modification database;

FIG. 8 is a flowchart showing the destination address modification process of the first preferred embodiment;

FIG. 9 is a flowchart showing the source address modification process of the first preferred embodiment;

FIGS. 10A through 10D show examples of the communications data of the first preferred embodiment;

FIG. 11 shows the outline of the network of the second preferred embodiment (No. 1);

FIG. 12 shows the outline of the network of the second preferred embodiment (No. 2);

FIG. 13 shows the configuration of each device in the second preferred embodiment;

FIGS. 14A through 14C show the structures of databases;

FIG. 15 is a flowchart showing the address modification process of the second preferred embodiment;

FIG. 16 is a flowchart showing the sorting process of the second preferred embodiment;

FIG. 17 is a flowchart showing the source address modification process of the second preferred embodiment;

FIGS. 18A through 18D show examples of the communications data of the second preferred embodiment (No. 1);

FIGS. 19A through 19D show examples of the communications data of the second preferred embodiment (No. 2);

FIG. 20 shows the outline of the network of the third preferred embodiment;

FIG. 21 shows the configuration of each device in the third preferred embodiment;

FIGS. 22A and 22B show the structures of databases;

FIG. 23 is a flowchart showing the destination address modification process of the third preferred embodiment;

FIG. 24 is a flowchart showing the information addition process of the third preferred embodiment;

FIG. 25 is a flowchart showing the modification information acquisition process of a modification processing unit in the third preferred embodiment;

FIG. 26 is a flowchart showing the modification process of a source address modification database in the third preferred embodiment;

FIGS. 27A through 27E show examples of communications data of the third preferred embodiment;

FIG. 28 shows the outline of the network of the fourth preferred embodiment (No. 1);

FIG. 29 shows the outline of the network of the fourth preferred embodiment (No. 2);

FIG. 30 shows the configuration of each device in the fourth preferred embodiment;

FIGS. 31A and 31B show the structures of databases;

FIG. 32 is a flowchart showing the modification information request process of a modification detection unit in the fourth preferred embodiment;

FIG. 33 is a flowchart showing the destination address modification process of the fourth preferred embodiment;

FIG. 34 is a flowchart showing the modification information generating process of the fourth preferred embodiment;

FIG. 35 is a flowchart showing the modification information acquisition process of the fourth preferred embodiment;

FIG. 36 is a flowchart showing the modification process of a transmitter database in the fourth preferred embodiment;

FIGS. 37A through 37C show examples of the communications data of the fourth preferred embodiment (No.1);

FIGS. 38A through 38C show examples of the communications data of the fourth preferred embodiment (No.2); and

FIG. 39 shows storage media.

### DESCRIPTION OF THE PREFERRED EMBODIMENTS

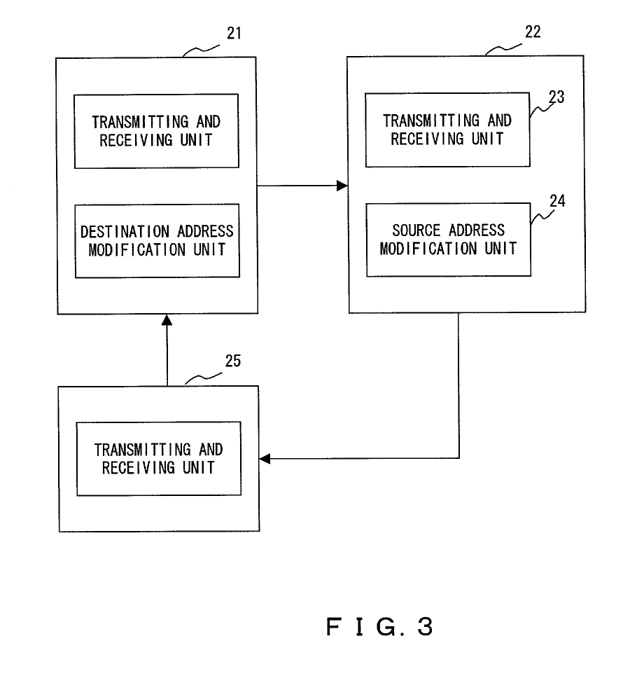

The preferred embodiments of the present invention are described below with reference to the drawings. FIG. 3 shows the basic configuration of one preferred embodiment of the present invention.

The address of communications data transmitted from a communications device 25 to a specific communications device is modified by an address modification device 21 and the data are transferred to a communications device 22.

The source address modification unit 24 of the communications device 22 modifies the source address of data in response to the communications data received by a transmitting and receiving unit 23 to the pre-modification address.

Thus, the response data can be transmitted from the communications device 22 on the receiving side to the communications device on the originating side without going through the address modification device 21. Therefore, even if a route leading from the communications device 22 to the communications device 25 on the originating side through the address modification device 21 includes a redundant route, the response data can be transmitted from the communications device 22 on the receiving side to the communications device 22 on the originating side along an optimal route.

The source address modification unit 24 is not necessarily provided in the communications device 22 to which the communications data are transferred from the communications device 25, and it can also be provided in another communications device on the network.

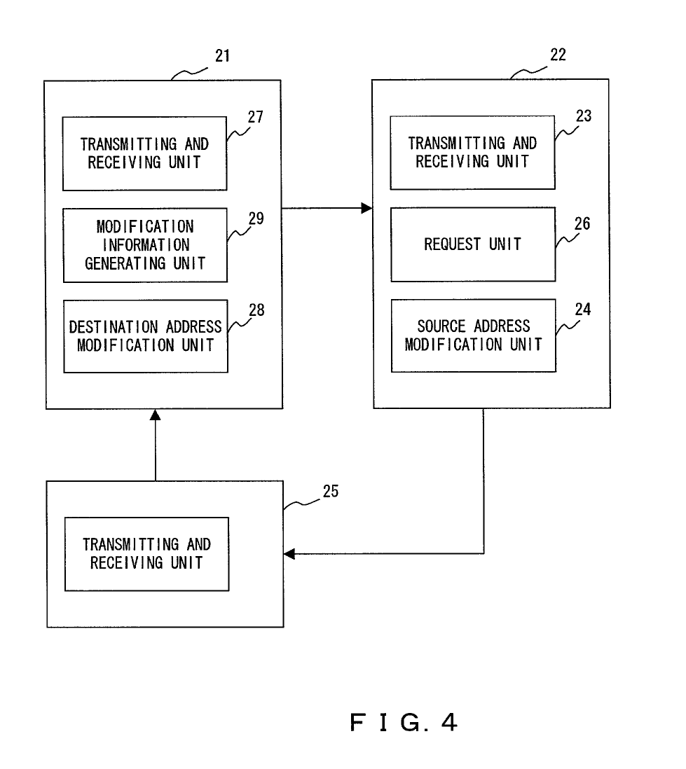

FIG. 4 shows the basic configuration of another preferred embodiment. A communications device 22 connected to a network with an address modification device 21 comprises a transmitting and receiving unit 23 transmitting and receiving communications data, a request unit 26 requesting the address modification device 21 to transmit the address modification information of the received communications data and a source address modification unit 24 modifying the source address of data in response to the communications data based on the modification information transmitted from the address modification device 21.

In this embodiment, the communications device 22 requests the address modification device 21 to transmit address modification information and modifies the source address of response data based on the transmitted modification information. Since the response data can be transmitted the response data with the original destination address as the source address, the communications device 25 on the originating side can recognize the response data as data in response to the transmission data. Therefore, response data can be transmitted to the communications device 25 on the originating side without going through the address modification device 21 and a communications route can be optimized.

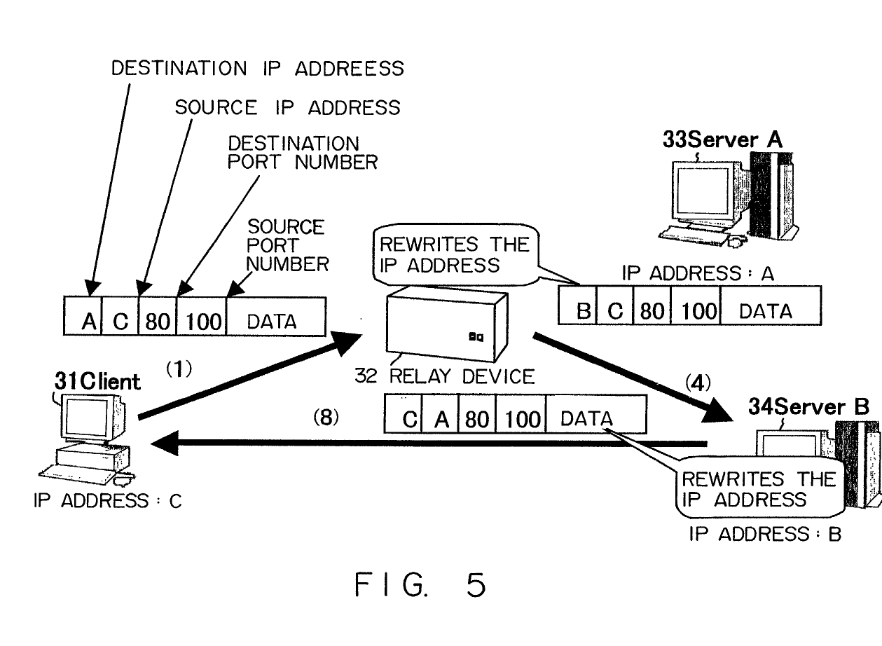

FIG. 5 shows the outline of the network of the first preferred embodiment of the present invention.

This network comprises a client 31, a relay device (address modification device) 32, a server 33 (server A) and a server 34 (server B).

In FIG. 5, the client 31 has a function to transmit and receive communications data. The relay device 32 has an address modification function and modifies the address of received data to the IP address of another server, the receiving data address of which is predetermined.

Each of the servers (communications devices) 33 and 34 has both a function to transmit and receive communications data and a function to perform a communications process corresponding to the content of the communication data. The server 34 further has a function to modify the source address of response data.

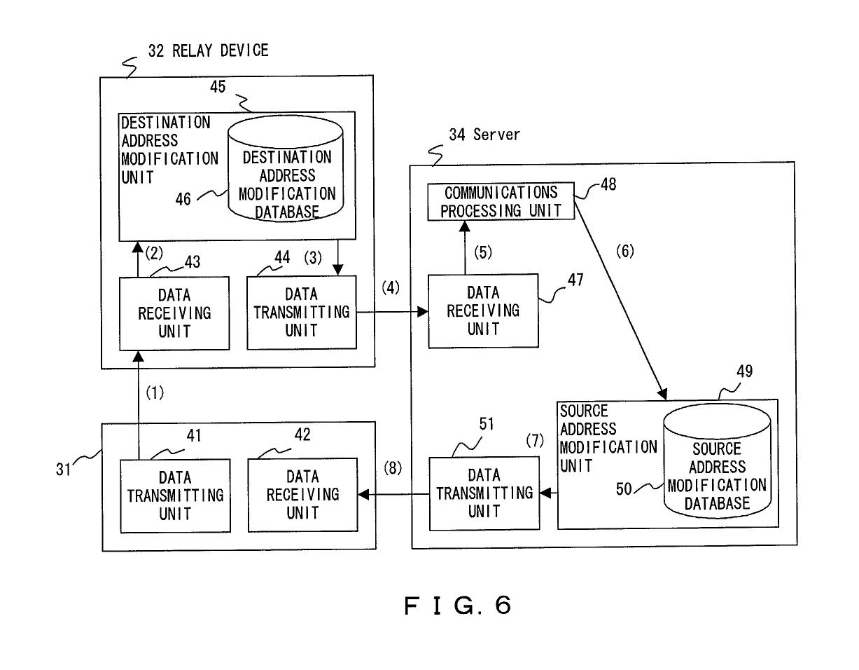

FIG. 6 shows the respective configurations of the client 31, relay device 32 and server 34 in the first preferred embodiment.

The client 31 further comprises a data transmitting unit 41 transmitting data and a data receiving unit 42 receiving data.

The relay device 32 further comprises a data receiving unit 43 receiving data, a data transmitting unit 44 transmitting data and a destination address modification unit 45 modifying the address of received communications data based on data registered in an destination address modification database 46, which is provided in the destination address modification unit 45.

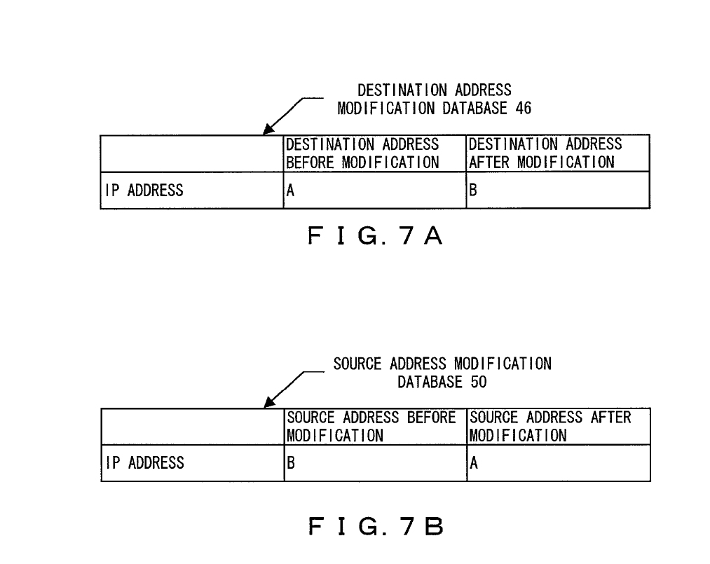

FIG. 7A shows an example of the data registered in the destination address modification database 46. Both a destination IP address to be modified (in FIG. 7A, the IP address A of the server 33) and a destination IP address after modification (in FIG. 7A, the IP address B of the server 34) are registered in the destination address modification database 46. The destination address modification unit 45 of the relay device 32 checks whether the address of received communications data are registered in the destination address modification database 46. If the address is registered, the destination address modification unit 45 modifies the address to the address registered in the destination address modification database 46.

The server 34 further comprises a data receiving unit 47, a communications processing unit 48 performing a communication process requested by the client 31, a source address modification unit 49 modifying the source address of response data used to transmitting a process result and a source address modification database 50 registering both a source address to be modified and a source address after modification, which is provided in the source address modification unit 49.

FIG. 7B shows an example of data registered in the destination address modification database 46. Both a source IP address to be modified (in FIG. 7B, the IP address B of the server 34) and a destination IP address after modification (in FIG. 7B, the IP address A of the server 33) are registered in the source address modification database 50. The source address modification unit 49 of the server 34 modifies the source address of transmission data to the source address registered in the source address modification database 50 (in this case, the IP address A of the server 33).

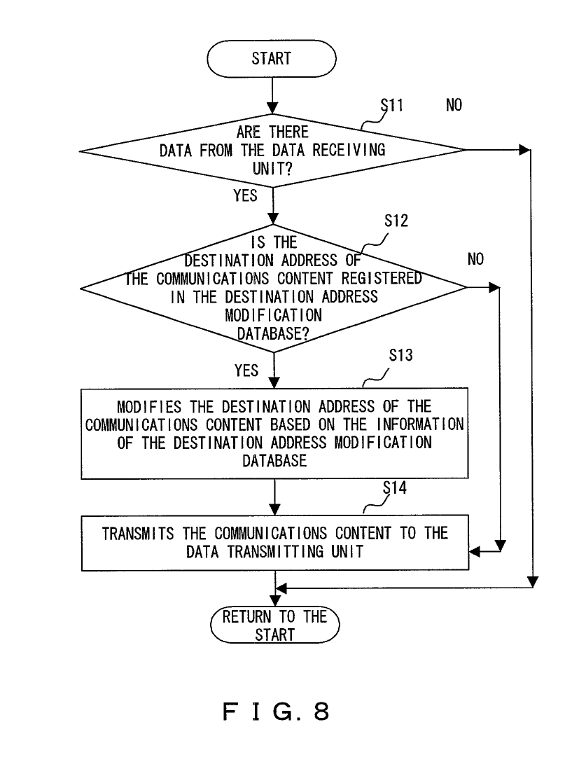

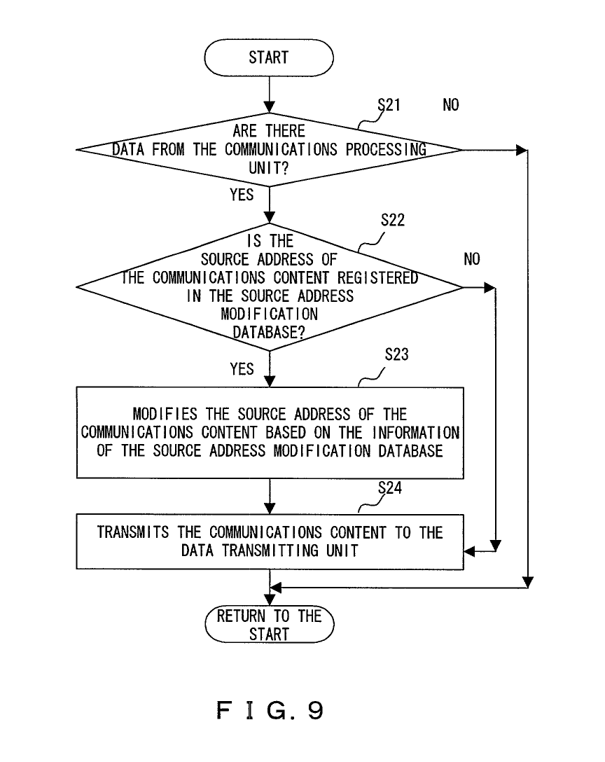

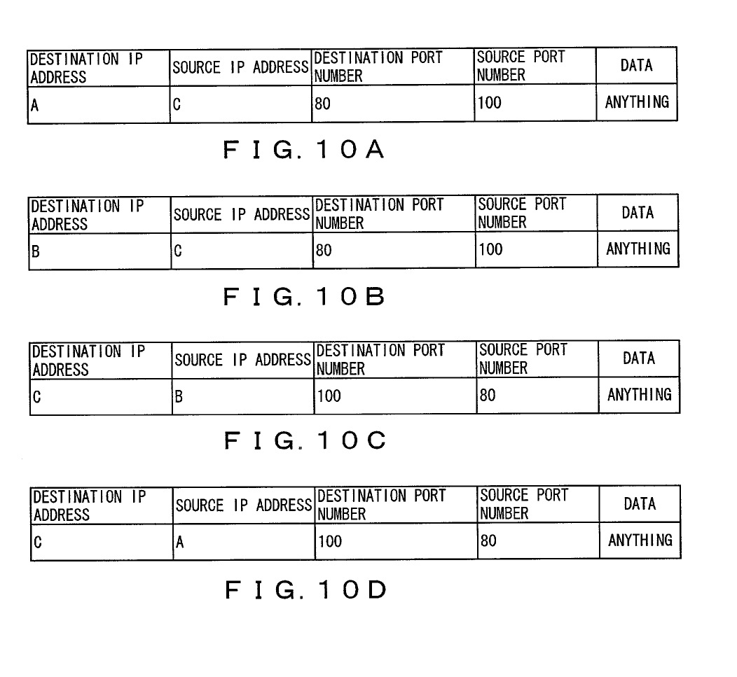

Next, the destination and source address modification processes of the first preferred embodiment are described with reference to the flowcharts shown in FIGS. 8 and 9; and the examples of transmission data shown in FIG. 10.

The client 31 transmits communications data making a request for a specific process to the server 33. Both the address to be modified and the address after modification are registered in advance in the destination address modification database 46 of the relay device 32. The relay device 32 judges whether there is a notice that the data receiving unit 43 has received communications data from another device, from the data receiving unit 43 (step S11 of FIG. 8).

On receipt of the notice that the relay device 32 has received communications data from another device (Yes in step S11), the destination address modification unit 45 of the relay device 32 judges whether the address of the communications content (communications data) is registered in the destination address modification database 46 (step S12 of FIG. 8).

If the address is registered (Yes in step S12), the destination address modification unit 45 modifies the address of the communications data to the modification address registered in the destination address modification database 46 (step S13). Then, the unit 45 outputs the communications data with the modified address to the data transmitting unit 44 (step S14). The data transmitting unit 44 of the relay device 32 transmits the communications data with the modified address to the address after modification.

FIG. 9 is a flowchart showing the source address modification process of the server 34. Both the source IP address to be modified and source IP address after modification are registered in advance in the source address modification database 50 of the server 34. The source address modification unit 49 of the server 34 judges whether the data receiving unit 43 has received response data, including the process result of a communication process, from the communications processing unit 48 (step S21 of FIG. 9).

If the response data are received from the communications processing unit 48 (Yes in step S21), the source address modification unit 49 judges whether the source address of the response data is registered in the source address modification database 50 (step S22). If the source address is registered in the source address modification database 50 (Yes in step S22), the unit 49 modifies the source address to the modification source address stored in the source address modification database 50 (step S23). Then, the unit 49 outputs the modified response data to the data transmitting unit 51 (step S24).

Next, both the destination address modification function of the relay device 32 and the source address modification function of the server 34 are described with reference to FIGS. 5, 6 and 8. It is assumed that the IP addresses of the client 31, server 33 and server 34 are C, A and B, respectively.

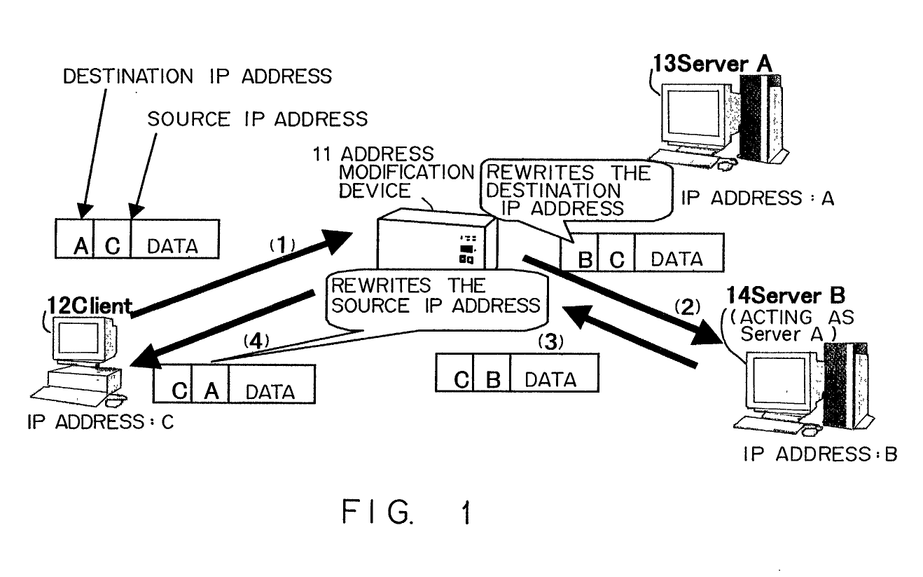

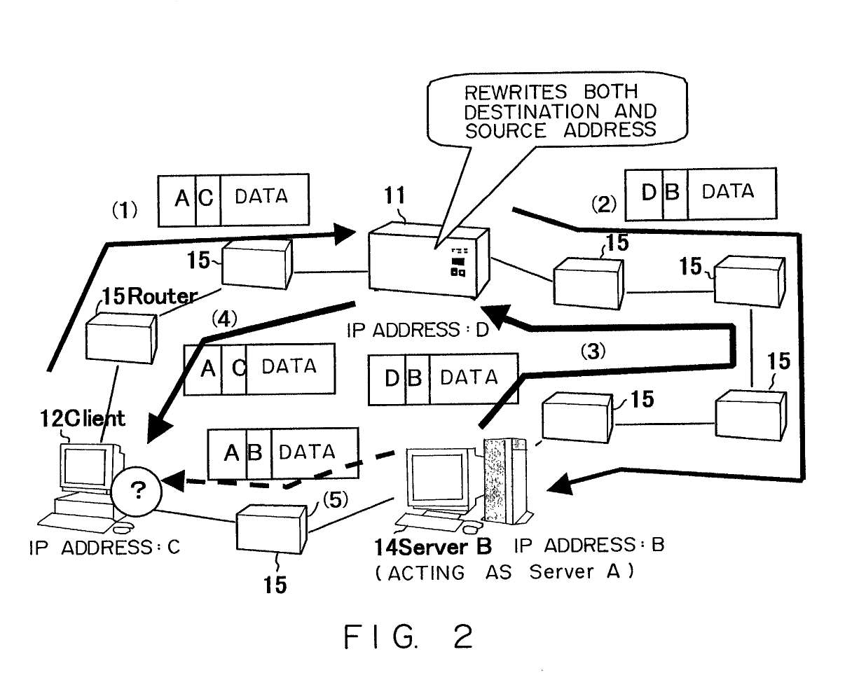

The client 31 transmits the communications data as shown in FIG. 1OA to the server 33. In this case, the IP address C of the client 31 and the IP address A of the server 33 are, respectively, designated as the source IP address and destination IP address. Data to be transmitted can be any kind of data, such as characters, images and the like.

When the data receiving unit 43 receives the communications data from the client 31 ((1) of FIGS. 5 and 6), the relay device 32 outputs the communications data to the destination address modification unit 45 ((2) Of FIG. 6). The destination address modification unit 45 collates the address of the communications data with the address registered in the destination address modification database 46. If the address of the communications data are registered in the destination address modification database 46, the destination address modification unit 45 modifies a destination IP address from the IP address A of the server 33 to the IP address B of the server 34. Then, the destination address modification unit 45 outputs the modified communications data to the data transmitting unit 44 ((3) of FIG. 6).

The transmitting unit 44 transmits the communications data with the modified address that are received from the destination address modification unit 45, to a network ((4) of FIG. 6).

FIGS. 10A and 10B indicate the communications data content before the address is modified by the relay device 32 and the communications data content after the address is modified by the relay device 32, respectively.

The data shown in FIG. 10A and the data shown in FIG. 10B are the same communications data, and the address of the communications data is modified from the IP address A of the server 33 to the IP address B of the server 34.

On receipt of the communications data ((4) of FIGS. 5 and 6), the data receiving unit 47 of the server 34 outputs the received data to the communications processing unit 48 ((5) of FIG. 6). The communications processing unit 48 performs some process depending on the communications content and outputs the response data with a rewritten data section to the source address modification unit 49 ((6) of FIG. 6).

The source address modification unit 49 modifies the destination IP address based on both the communications content and the data stored in the source address modification database 50.

FIGS. 10C and 10D show the communications data before the transmitter is modified by the transmitter modification unit 49 of the server 34 and the communications data after the transmitter is modified by the transmitter modification unit 49, respectively.

As shown in FIGS. 10C and 10D, the source address modification unit 49 sets the IP address of the server 33, which is the original source address, as the source address instead of the IP address of the unit 49.

The source address modification unit 49 outputs the response data with the modified source address to the data transmitting unit 51 ((7) of FIG. 6). The data transmitting unit 51 transmits the response data to a network ((8) of FIGS. 5 and 6). The client 31 recognizes the response data from the server 34 as a response from the server 33 to which the client 31 has transmitted the data ((8) of FIGS. 5 and 6).

According to the first preferred embodiment described above, since the server 34 has a source address modification function, response data can be transmitted to the client 31 without going through the relay device 32. Therefore, since the direct communications route between the server 34 and client 31 is shorter than the communications route between them through the relay device, data can be transmitted along a shorter communications route. Delay due to a communications route can be reduced accordingly.

Although in the preferred embodiment described above, the destination address modification database 46 or source address modification database 50 is provided in the relay device 32 or server 34, an external device can also store data and the data can also be accessed using a protocol, such as a LDAP (lightweight directory-access protocol), as requested.

Although anetwork composed of a client 31, a relay device 32 and a server 34 is used as an example, the present invention is not limited to such a configuration. A data transfer device and the like can also be located among the client 31, relay device 32 and server 34. The network can be arbitrarily configured.

Furthermore, although in the preferred embodiment described above, the relay device 32 and server 33 are used as separate devices, the server 33 can also have the functions of the relay device 32 and can also modify the address.

What is described above is applicable not only to the first preferred embodiment, but also to other preferred embodiments described below.

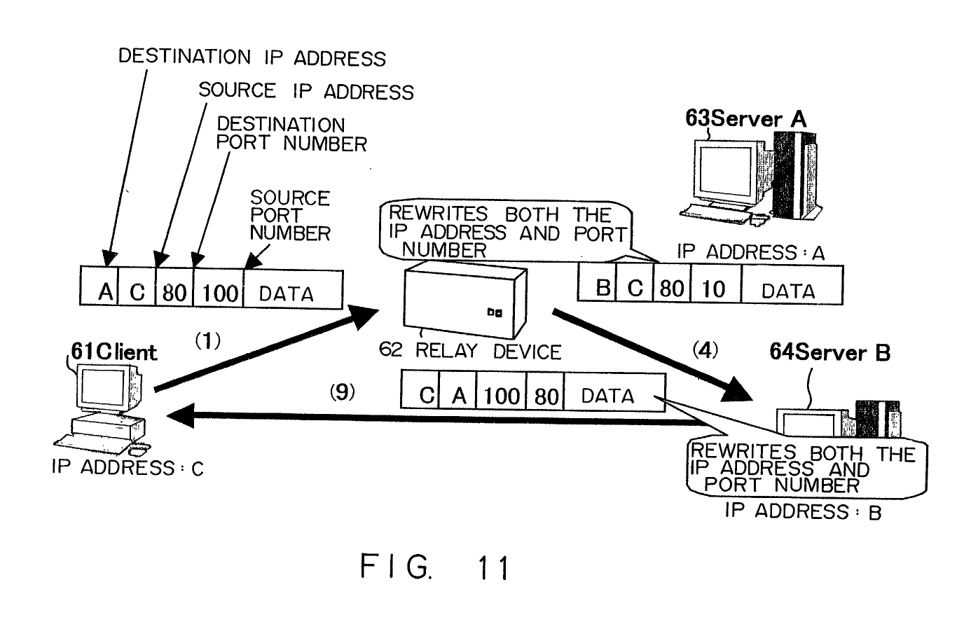

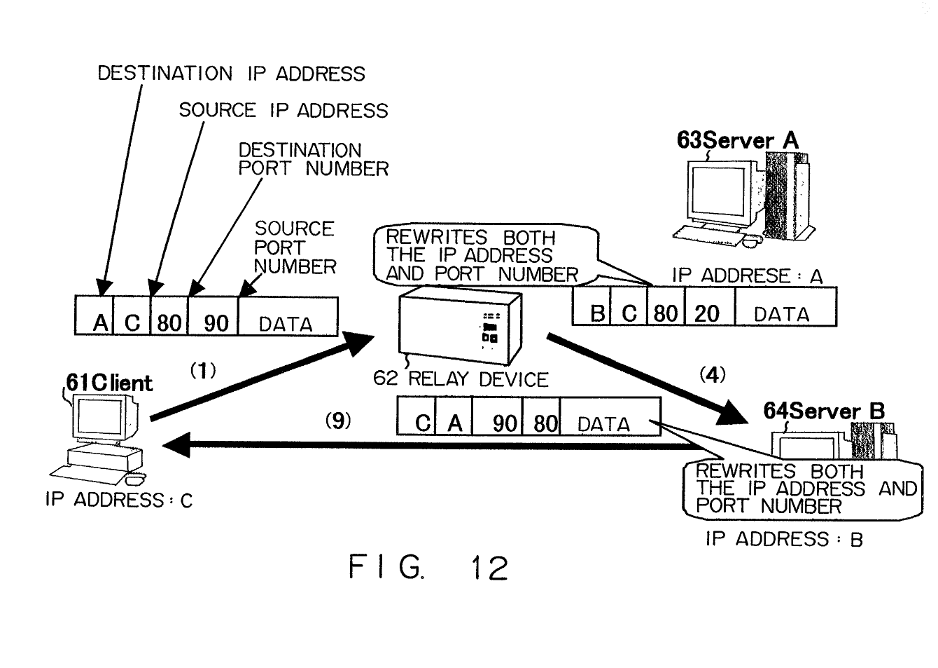

FIGS. 11 and 12 show the outline of the network in the second preferred embodiment of the present invention.

The configuration of the network shown in FIGS. 11 and 12 is basically the same as the configuration of the network of the first preferred embodiment shown in FIG. 5. The configuration of the network shown in FIGS. 11 and 12 differs from the configuration of the network shown in FIGS. 5 only in that a relay device 62 has a function to rewrite a port number and can select an arbitrary communications processing unit from a plurality of communications processing units based on the port number.

As shown in FIG. 11, when a client 61 transmits communications data with A, C, 80 and 100 designated as the destination IP address, source IP address, destination port number and source port number, respectively, to the server 63, a relay device 62 rewrites the IP address A of the server 63, which is the original destination address of the data, to the IP address B of the server 64 and further rewrites the source port number from 100 to 10 if the address of the communications data should be modified.

The server 64 rewrites the source IP address of response data from the IP address B of the server 64 to the IP address A, and further rewrites the destination port number and source port number to 100 and 80, respectively, which are used in the transmission data. The same description applies to FIG. 12.

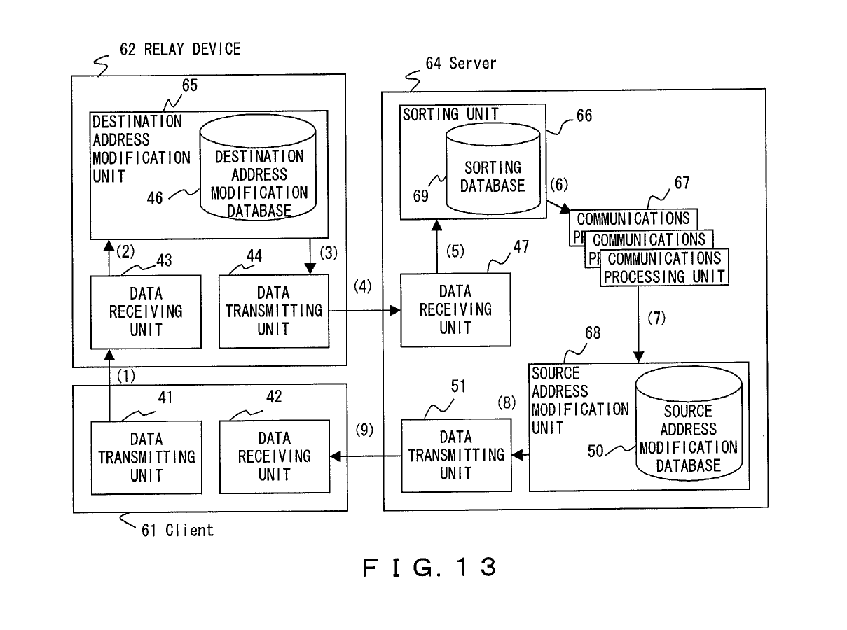

FIG. 13 shows the respective configurations of the client 61, relay device 62 and server 64 of the second preferred embodiment. In the following description, the same reference numeral is attached to a device or unit with the same function as each device or unit shown in FIG. 6, and the description is omitted.

If the address of received data should be modified, the destination address modification unit 65 of the relay device 62 rewrites the destination address and source port number or destination port number and outputs the data to the data transmitting unit 44.

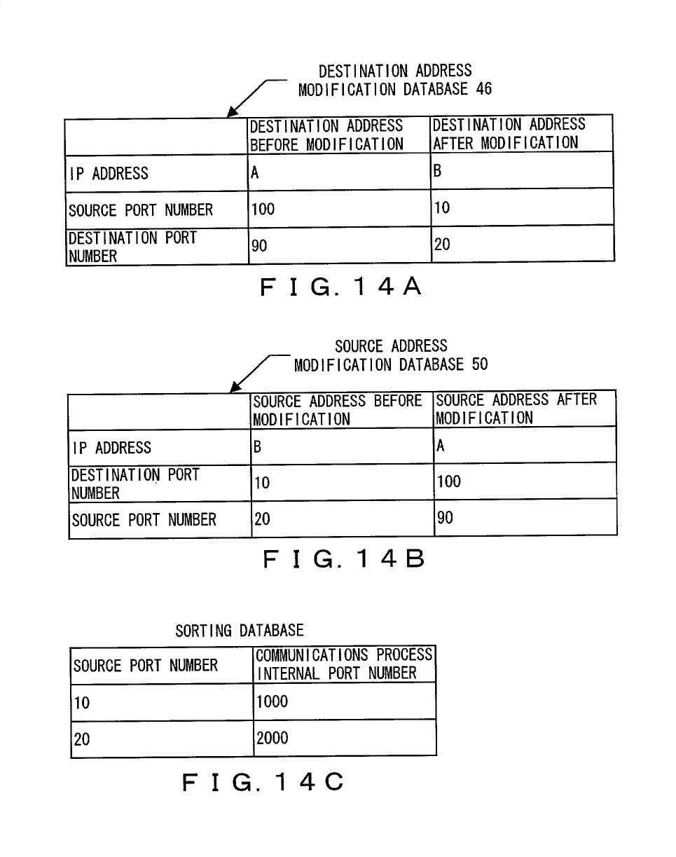

FIG. 14A shows examples of data registered in the address modification database. A destination IP address B after modification, a source port number 10 and a destination port number 20 are registered in advance in correspondence to a destination IP address A to be modified, a source port number 100 to be modified and a destination port number 90 to be modified, respectively, in the destination address modification database 46.

The sorting unit 66 of a server 64 sorts received communications data based on data registered in a sorting database 69 using the source port number as an identifier and requests the relevant communications processing unit 67 of a plurality of communications processing units 67 to perform the communications process. The communications processing unit 67 performs a process depending on the communications content and outputs the result to a source address modification unit 68. The source address modification unit 68 judges whether the source address of response data outputted from the communications processing unit 67 should be modified. If it is judged that the source address should be modified, the source address modification unit 68 modifies the source address and outputs the response data to the data transmitting unit 51.

FIGS. 14C and 14B show an example of the sorting database 69 and an example of the source address modification database 50, respectively.

As shown in FIG. 14C, internal port numbers 1000 and 2000 are registered in correspondence to source port numbers 10 and 20, respectively, in the sorting database 69.

As shown in FIG. 14B, a source IP address A after modification, a destination port number 100 after modification and a source port number 90 after modification are registered in correspondence to a source IP address B before modification, a destination port number 10 before modification and a source port number 20 before modification, respectively, in the source address modification database 50.

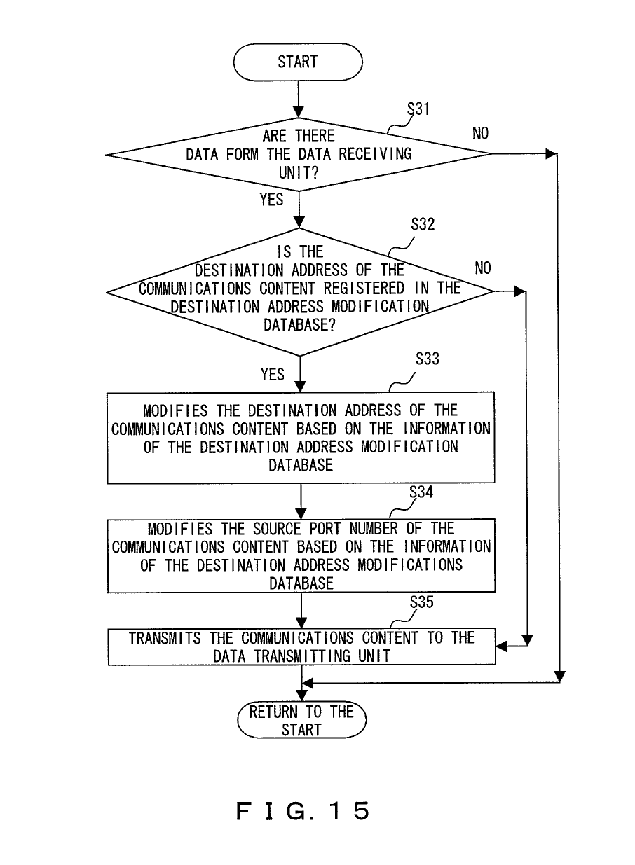

Next, the address modification process of the destination address modification unit 65 in the relay device 62 is described with reference to the flowchart shown in FIG. 15.

The destination address modification unit 65 judges whether there are communications data from the data receiving unit 43 (step S31 of FIG. 15). If there are communications data (Yes in step S31), the unit 65 further judges whether the address of the communications data are registered in the destination address modification database 46 (step S32).

If the address of the communications data is registered in the destination address modification database 46 (Yes in step S32), the unit 65 modifies the address of the communications data based on the information of the destination address modification database 46 (step S33). The unit 65 further modifies the source port number based on the information of the destination address modification database 46 (step S34) Then, the unit 65 outputs the communications data with the modified destination address and source port number to the data transmitting unit 44 (step S35).

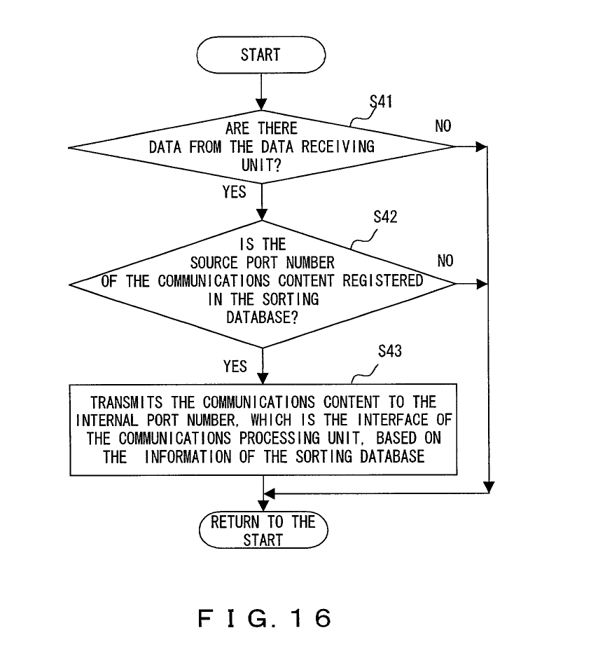

Next, the sorting process of the sorting unit 66 in the server 44 is described with reference to the flowchart shown in FIG. 16.

The sorting unit 66 judges whether there are communications data from the data receiving unit 47 (step S41 of FIG. 16). If there are communications data (Yes in step S41), the unit 66 further judges whether the source port number of the communications data is registered in the sorting database 69 (step S42).

If the source port number is registered in the sorting database 69 (Yes in step S42), the unit 66 outputs the communications data to a communications processing unit 67 with an internal port number corresponding to the source port number (step S43).

The destination port number designated by the client 61 can be converted into an internal port number by the process described above, and the communications processing unit 67 corresponding to the internal port number can perform the process. Thus, even if the communications processing unit 67 (communications port, etc.) performing the process designated by the client is used, the relay device 62 can designates another communications processing unit 67 of the server 64.

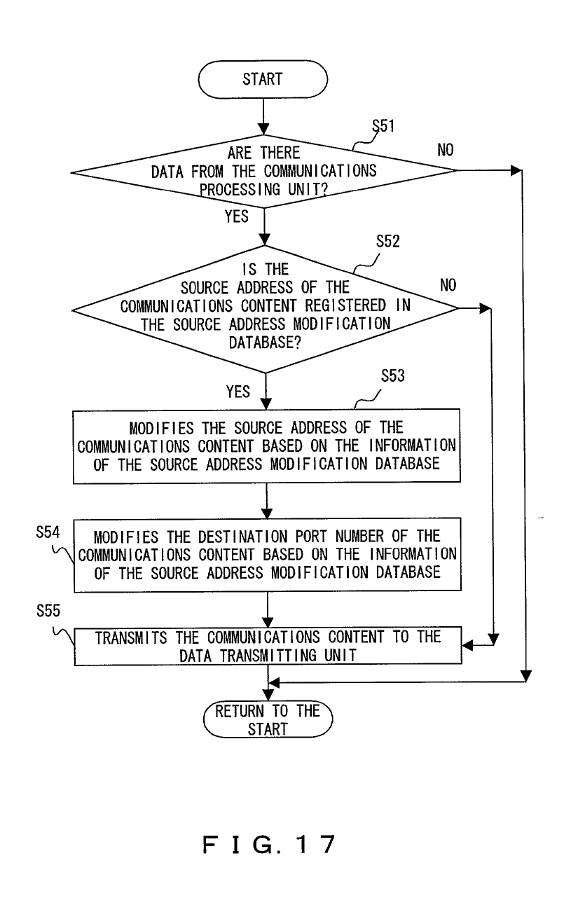

Next, the source address modification process of the source address modification unit in the server 64 is described with reference to the flowchart shown in FIG. 17.

The source address modification unit 68 judges whether there are response data, including a process result of a service designated by the communications data from the communications processing unit 67 (step S51 of FIG. 17). If there are response data (Yes in step S51), the unit 68 further judges whether the source address of the response data is registered in the source address modification database 50 (step S52).

If the source address is registered in the source address modification database 50 (Yes in step S52), the unit 68 modifies the source address of the response data based on the content of the source address modification database 50 (step S54). Then, the unit 68 outputs the response data with the modified source address to the data transmitting unit 51 (step S55).

Next, the respective processes of the relay device 62 and server 64 in the second preferred embodiment are described with reference to FIG. 13.

As shown in FIG. 14A, IP address B after modification and a source port number 10 after modification are registered in advance in correspondence to IP address A to be modified and source port number 100, respectively, in the destination address modification database 46 of the relay device 62.

On receipt of communications data from the client 61 ((1) of FIG. 13), the relay device 62 outputs the communications data to the destination address modification unit 65 ((2) of FIG. 13). The destination address modification unit 65 collates the address of the communications data with the address registered in the destination address modification database 46. If the matching address is registered, the unit 65 modifies the address to the address after modification registered in correspondence to the address. For example, if the IP address A of the server 63 is designated as an address, the unit 65 designates the IP address B of the server 64 corresponding to the address as the address of the communications data. Furthermore, the unit 65 modifies the source port number from 100 to 10. Then, the unit 65 outputs the communications data with the modified address to the data transmitting unit 44 ((3) of FIG. 13).

The sorting unit 66 converts the source port number to an internal port number based on identifiers included in received communications data, such as both the source port number and information registered in the sorting database 69, specifies a communications processing unit 67 by the internal port number and makes the relevant communications processing unit 67 perform a communications process ((6) of FIG. 13). As shown in FIG. 14C, the internal communications process port number 1000 of the server 64 is registered in advance in correspondence to source port number 10 in the sorting database 69. If the relay device designates 10 as the source port number, the port number is converted into internal port number 1000 and the communications processing unit 67 designated by the internal port number is operated.

The communications processing unit 67 performs the process based on the content of the communications data, generates data in response to the communications data that is requested based on the process result and outputs the response data to the source address modification unit 68 ((7) of FIG. 13).

The source address modification unit 68 modifies the source address of response data based on both the response data and the information of the source address modification database 50. For example, the unit 68 modifies the source address from the IP address B of the unit 68 to the IP address A of the server 63, which is the original address. Furthermore, the unit 68 rewrites the destination port number and source port number based on the destination port number and source port number that are registered in the source address modification database 50. In this preferred embodiment, destination port number 10 (the source port number of the relay device 62) is converted into 100, which is the source port number of the client 61. Then, the source address modification unit 68 outputs the response data with both the modified source address and destination port number to the data transmitting unit 51 ((8) of FIG. 13).

The data transmitting unit 51 transmits the response data to the client 61 ((9) of FIG. 13).

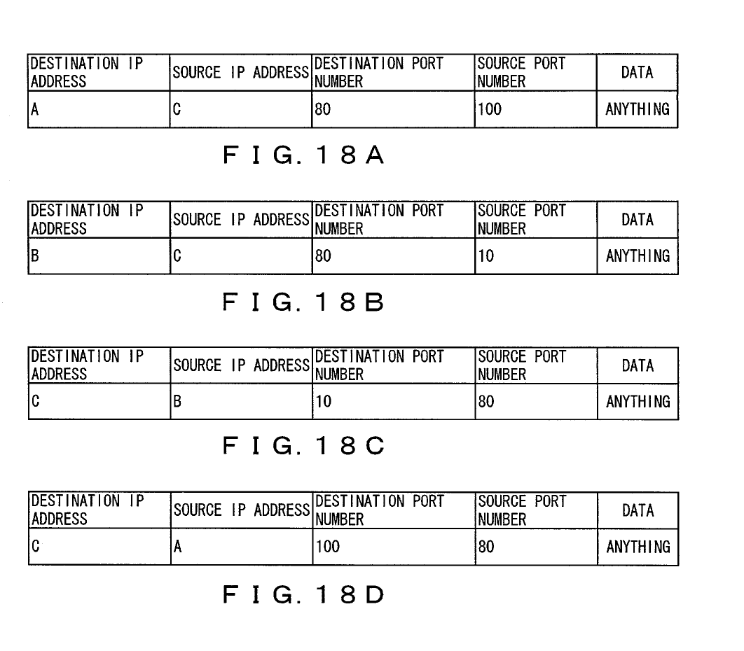

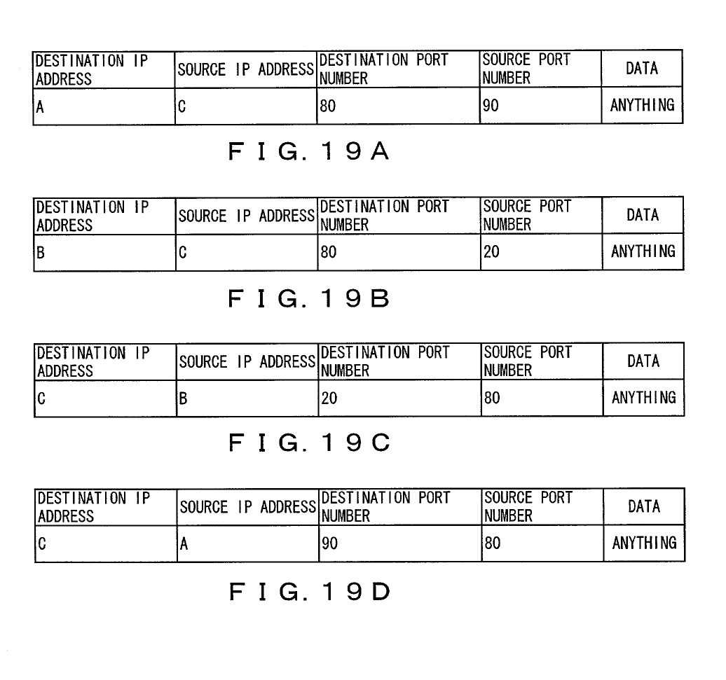

Next, the destination and source address modification processes of the relay device and server 64 are described with reference to the communications data shown in FIGS. 18 and 19, respectively.

FIGS. 18A through 18D and 19A through 19D show the contents of communications data before and after the destination and source address modification processes of the relay device 62 and server 64, respectively, are modified.

On receipt of communications data with destination IP address A, destination port number 80 and source port number 100, which are shown in FIG. 18A, from the client 61, the relay device 62 modifies the destination IP address of the communications data, destination port number and source port number to B, 80 and 10, respectively, as shown in FIG. 18B ((4) of FIG. 11) and transmits the communications data to a network. These address and port number modifications are made based on the destination IP address and source port number registered in the destination address modification database, as shown in FIG. 14A.

On receipt of communications data making a request for a service from the relay device 62, the server 64 generates response data to transmit process result data after performing a communications process designated by the received communications data. In this case, as shown in FIG. 18C, the destination IP address, source IP address, destination port number and source port number of the response data in the initial state are C, B, 10 and 80, respectively.

The source address modification unit 68 of the server 64 modifies the source address of the response data and destination port number to the IP address A of the server 63, which is the original destination, and 100, respectively, and outputs the response data to data transmitting unit 51 ((8) of FIG. 13). These source address and port number modifications by this source address modification unit 68 are made based on both the IP address and destination port number which are registered in the source address modification database 50 shown in FIG. 14B.

On receipt of the response data, the client 61 can recognize the response data from the server 64 as data in response to the transmission data that the client 61 has transmitted.

Similarly, on receipt of communications data with destination IP address A, destination port number 80 and source port number 90, which are shown in FIGS. 12 and 19A, from the client 62 ((1) of FIG. 12), the relay device 62 modifies the destination IP address and source port number of the communications data to B and 20, respectively, as shown in FIG. 19B, and transmits the communications data to a network ((4) of FIG. 12).

On receipt of the communications data making a request for a service from the relay device 62, the server 64 generates response data to transmit process result data after performing a communications process designated by the received communications data. In this case, as shown in FIG. 17C, response data with destination IP address C, source IP address B, destination port number 20 and source port number 80 are generated from the content of the received communications data. The source address modification unit 68 of the server 64 modifies the source address and destination port number to the IP address A of the server 63, which is the original destination, and 90, respectively, and transmits the response data to a network ((9) of FIG. 12).

According to the second preferred embodiment described above, response data can be transmitted to the client 61 without going through the relay device 62 by modifying the source address of the response data. Therefore, even if the communications route through the relay device 62 is long, the actual communication route can be reduced. Furthermore, even if the communications processing unit of the server 64 designated by the client 61 is used, by modifying a communication port number designated by the client 61, the communications process can be performed using another communications processing unit of the server 64.

Although in the second preferred embodiment described above, the relay device 62 modifies a source port number, a destination port number can also be modified. Alternatively, another identifier for designating the communications processing unit of the server 64 and the like can be used.

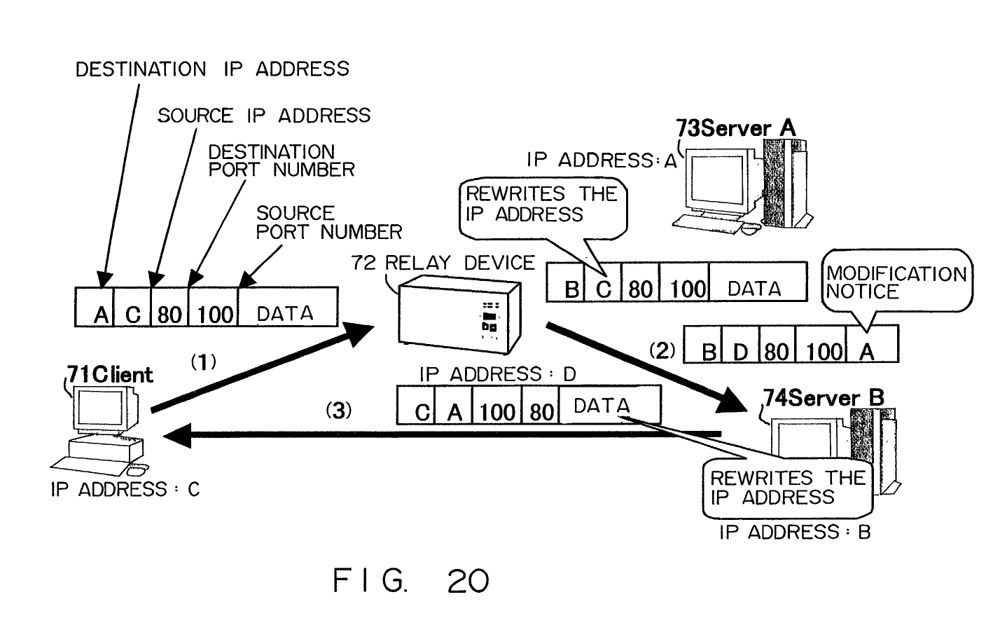

FIG. 20 shows the outline of the network of the third preferred embodiment of the present invention.

This network is composed of a client 71, a relay device 72, a server 73 (server A) and a server 74 (server B) as in the preferred embodiment described above.

The relay device 72 has both an address modification function and an information addition function, and notifies the server 74, to which the address of the data has been modified, of information about address modification. The server 74 has a function to obtain the information about address modification from the relay device 72 and to modify the source address of response data based on the obtained information. Thus, in the third preferred embodiment, server 74 can obtain information for modifying the source address from the relay device 72 without storing the information for modifying the source address in advance. Then, by modifying the source address based on the information, the server 74 can communicate with the client 71 without going through the relay device 72 in the backward communications.

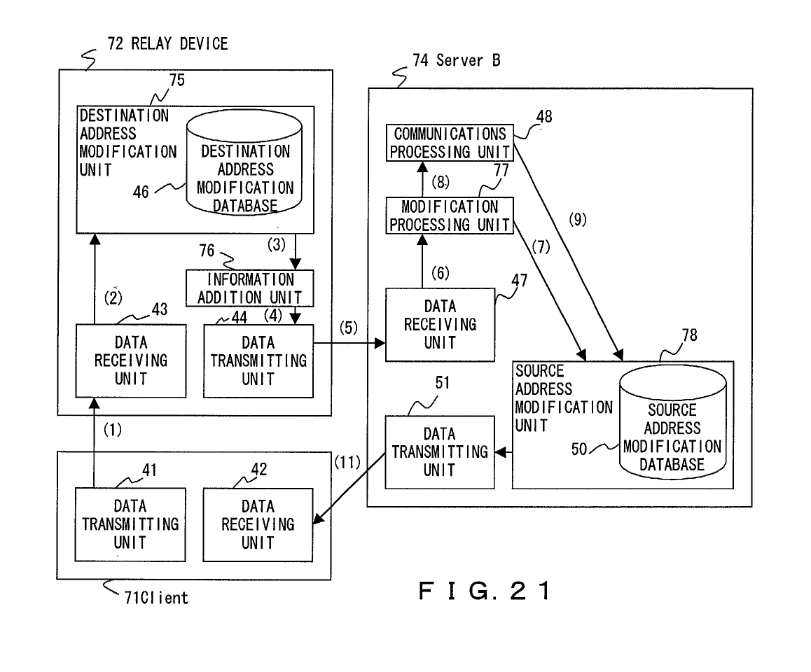

FIG. 21 shows the respective configurations of the client 71, relay device 72 and server 74 in the third preferred embodiment.

The client 71 comprises a data transmitting unit 41 transmitting data and a data receiving unit 42 receiving data.

The relay device 72 comprises a data receiving unit 43 receiving data, a data transmitting unit 44 transmitting data, a destination address modification unit 75 modifying the destination address of received communications data, based on data registered in an destination address modification database 46, which is provided in the unit 75 and an information addition unit (modification information generating unit) 76 generating destination address modification information.

The destination address modification unit 75 of the relay device 72 checks whether the destination address of the received communications data is registered in the destination address modification database 46. If the address is registered, the unit 75 modifies the address to the address registered in the destination address modification database 46.

The information addition unit 76 generates communications data, including modification information indicting the address before modification of the communications data.

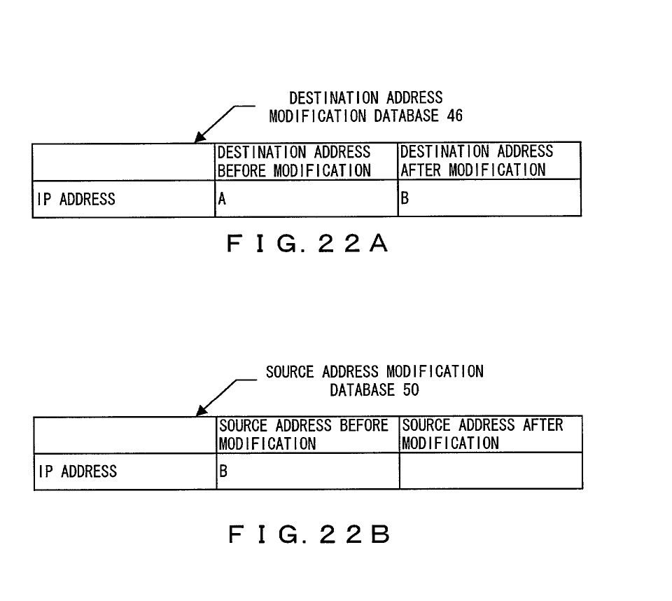

FIG. 22A shows an example of data registered in the destination address modification database 46. Both a destination IP address to be modified (in FIG. 22A, IP address A of the server 73) and a destination IP address after modification (in FIG. 22A, IP address B of the server 74) are registered in advance in the destination address modification database 46.

The server 74 comprises a data receiving unit 47, a modification processing unit 77 extracting information about a source address to be modified from address modification information received from the relay device 72, a communications processing unit 48 performing a process requestedby the client 71, a source address modification unit 78 modifying the source address of response data and a source address modification database 50 storing both the source address to be modified and source address after modification.

FIG. 22B shows an example of data registered in the source address modification database 50. In this case, a section of the source address modification database 50 for storing the source IP address after modification is blank, and the source address modification unit 78 writes the source IP address after modification based on modification information transmitted from the relay device 72.

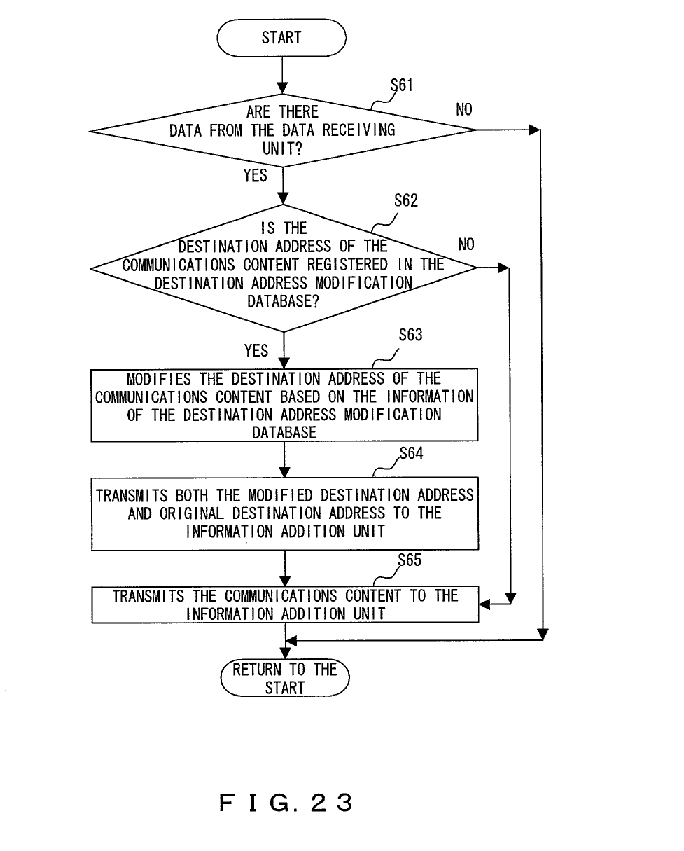

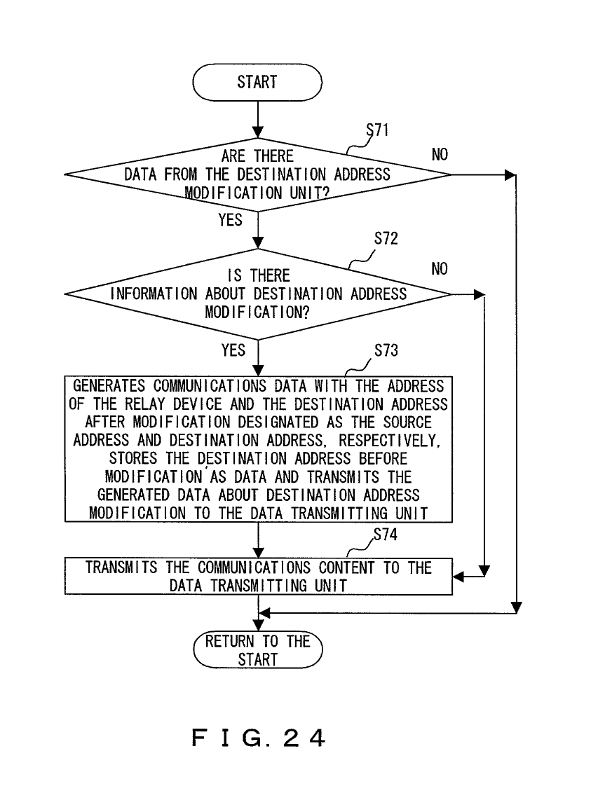

Next, both the destination address modification process and information addition process of the relay device 72 are described with reference to the flowcharts shown in FIGS. 23 and 24, respectively.

First, the client 71 transmits communications data for making a request for a prescribed process to the server 73. The relay device 72 judges whether there is a notice of receiving the communications data from the data receiving unit 43 (step S61 of FIG. 23). If there is the notice of having received the communications data (Yes in step S61), the destination address modification unit 75 of the relay device 72 judges whether the address of the communications data are registered in the destination address modification database 46 (step S62 of FIG. 23). The destination address modification database 46 of the relay device 72 stores in advance both the destination IP address to be modified and destination IP address after modification.

If the address is registered (Yes in step S62), the destination address modification unit 75 modifies the destination address of the communications data to the address after modification registered in the destination address modification database 46 (step S63) The destination address modification unit 75 outputs information indicating both the address to be modified and address after modification to the information addition unit 76 (step S64). The destination address modification unit 75 further outputs the communications data received from the client 71 to the information addition unit 76 (step S65).

The information addition unit 76 judges whether there is data from the destination address modification unit 75 (step 71 of FIG. 24). If there is data from the destination address modification unit 75 (Yes in step S71), the information addition unit 76 further judges whether the data include information about address modification (step S72).

If there is information about address modification (Yes in step S72), the information addition unit 76 generates communications data with the relay device 72 and source address modified based on the data of the destination address modification database 46 designated as the source and destination addresses, respectively, and outputs the communications data, including the generated address modification information, to the data transmitting unit 44 (step S73). The information addition unit 76 further outputs the communications data received from the client 71 to the data transmitting unit 44 (step S74).

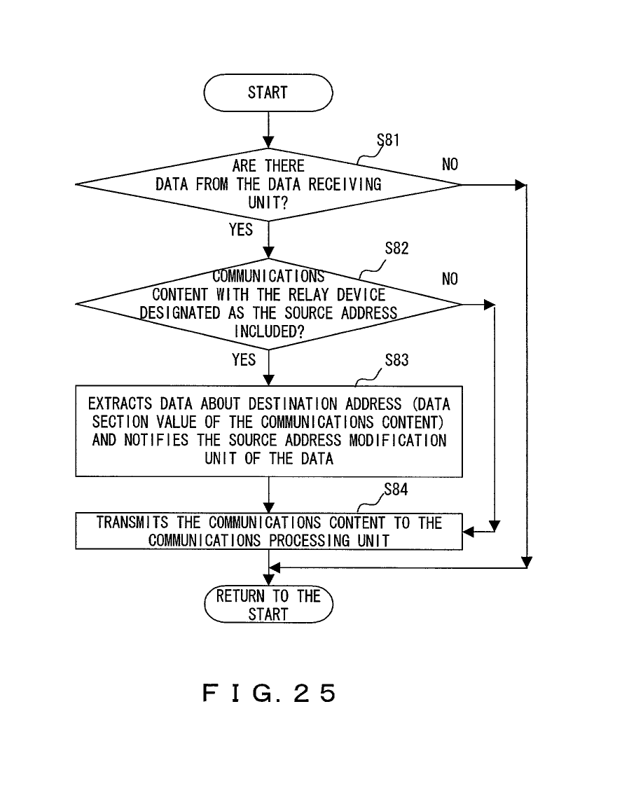

Next, the modification information obtaining process of the modification processing unit 77 in the server 44 is described with reference to the flowchart shown in FIG. 25.

The modification processing unit 77 judges whether there are data from the data receiving unit 47 (step S81 of FIG. 25). If there are data (Yes in step S81), the modification processing unit 77 judges whether the source address of the communications data is the relay device 72 (step S82).

If the server 74 receives communications data with the relay device 72 designated as the source address (Yes in step S82), the unit 77 extracts information about address modification (data indicating the address before modification in the data section of communications data) from the communications data and notifies the source address modification unit 78 of the extracted data, that is, address modification information (step S83). The unit 77 further outputs the communications data received by the data receiving unit 47 to the communications processing unit 48 (step S84).

Thus, information about the address modification transmitted from the relay device 72 is extracted from the modification processing unit 77 and is outputted to the transmitting modification unit 78.

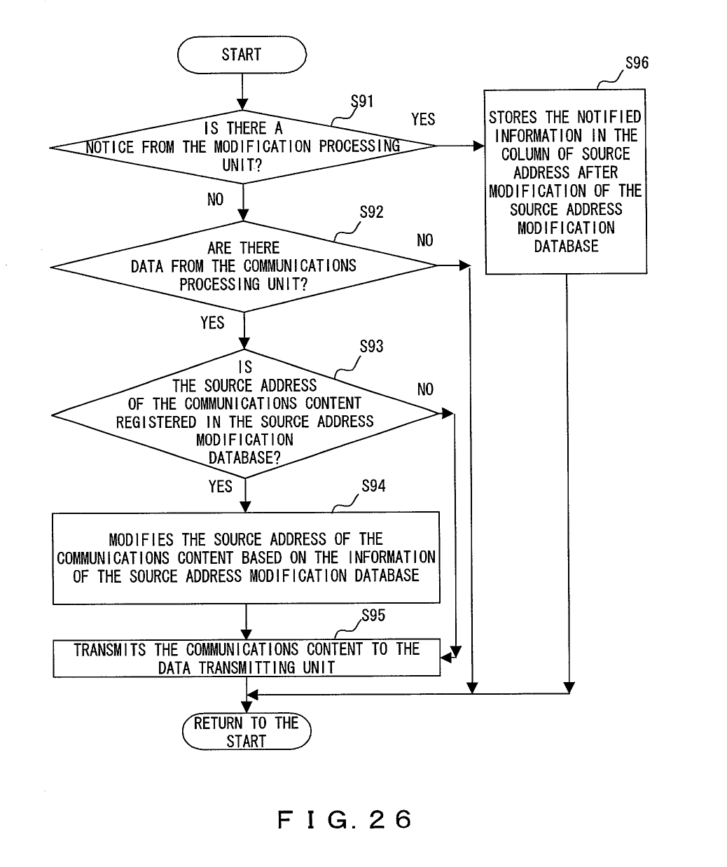

Next, the update process of the source address modification database 50 in the transmitter modification unit 78 is described with reference to the flowchart shown in FIG. 26.

The source address modification unit 78 judges whether there is a notice of having extracted address modification information, from the modification processing unit 77 (step S91 of FIG. 26). If there is no notice (No in step S91), the unit 78 further judges whether there are response data, including a process result from the communications processing unit 48 (step S92).

If there are response data from the communications processing unit 48 (Yes in step S92), the unit 78 judges whether the source address of the response data are registered in the source address modification database 50 (step S93).

If the source address is registered in the source address modification database 50 (Yes in step S93), the unit 78 modifies the source address of the response data to the modification address registered in the source address modification database 50 (step S94). Then, the unit 78 transmits the response data with the modified source address to the data transmitting unit 51 (step S95).

If in step S91 there is a modification notice from the modification processing unit 77 (Yes in step S91), the flow proceeds to step S96, and the notified address modification information is stored in the source address modification database 50 as the after-modification item of the relevant (source address after modification).

Thus, data indicating the address after modification of the source address modification database 50 can be set based on the address modification information extracted by the modification processing unit 77.

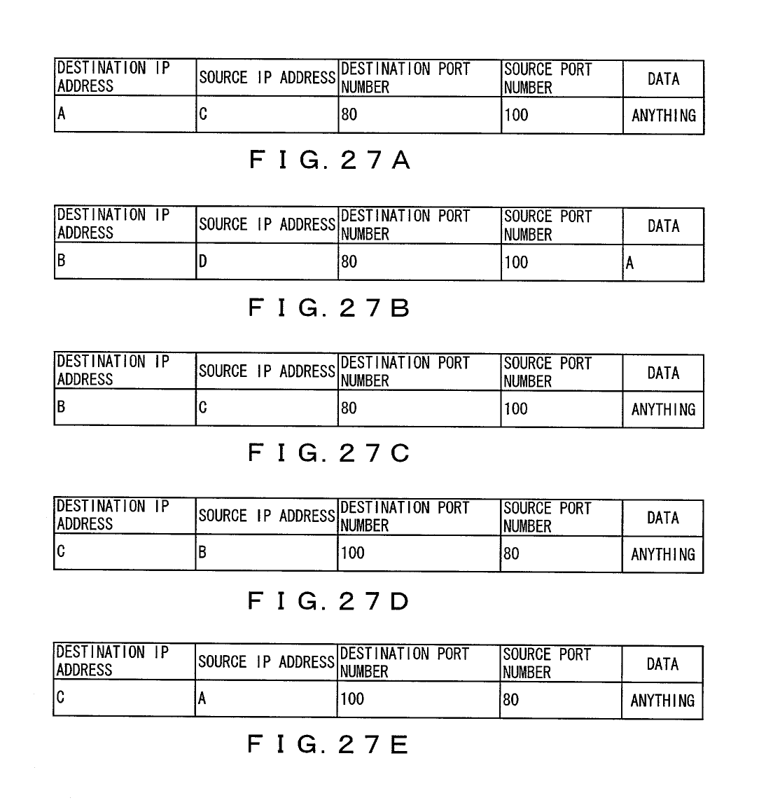

Next, the process operations of both the relay device 62 and server 64 in the third preferred embodiment are described using the communications data shown in FIGS. 27A through 27E as examples, with reference to FIGS. 20 and 21, respectively.

FIGS. 27A through 27E show both the communications data before a destination address or source address is modified in the relay device 62 and server 64, and the contents after the modification.

On receipt of communications data with A, C, 80 and 100 designated as the destination IP address, source IP address, destination port number and source port number, respectively, as shown in FIG. 27A, from the client 71 ((1) of FIGS. 20 and 21), the destination address modification unit 76 of the relay device 72 modifies the destination IP address from A to B, as shown in FIG. 14C, based on both the address of the communications data and the data registered in the destination address modification database 46, and further outputs the data about address modification to the information addition unit 76 ((3) of FIG. 21).

The information addition unit 76 adds a destination IP address before modification to the data section based on the data about a destination address received from the destination address modification unit 75 and outputs both communications data with the IP address D of the relay device 72 designated as the source IP address, that is, the communications data shown in FIG. 27B and communications data received from the client 71 shown in FIG. 14C, to the data transmitting unit 44 ((4) of FIG. 21).

The data transmitting unit 44 transmits both the communications data, including address modification information and communications data with the modified address that are outputted from the information addition unit 76, to the server 74 ((5) of FIG. 21).

On receipt of the communications data from the relay device 72 ((5) of FIG. 21), the data receiving unit 47 of the server 74 outputs the received data to the modification processing unit 77 ((6) of FIG. 21). The modification processing unit 77 extracts information indicating a source address after modification from the received modification information and outputs the extracted information to the source address modification unit 78 ((7) of FIG. 21). The modification processing unit 77 further outputs the communications data of the client 71 to the communications processing unit 48 ((8) of FIG. 21).

The communications processing unit 48 performs a process based on the process request content of the data section of the communications data, generates response data, including the process result and outputs the data to the source address modification unit 78 ((9) of FIG. 21). The response data to be generated at this time are communications data with the IP address C of the client 71 and the IP address B of the server 74 designated as the destination IP address and source IP address, respectively.

The source address modification unit 78 sets, for example, A as a source IP address after modification corresponding to the source IP address B before modification of the source address modification database 50 shown in FIG. 22B. Then, the source address modification unit 78 modifies the source address of the communications data based on the data of the source address modification database 50 and outputs the data to the data transmitting unit 51 ((10) of FIG. 21). Thus, as shown in FIG. 27E, the source IP address of the response data is modified from B to A.

The data transmitting unit 51 transmits the response data with the modified source address to the client 71 ((11) of FIGS. 20 and 21).

According to the third preferred embodiment described above, the server 74 can receive address modification information transmitted from the relay device 72 without storing information for modifying the source address in advance and can modify the source address of communications data based on the modification information. Then, since the server 74 can transmit response data to the client 71 without going through the relay device 72, backward communications can be conducted along an optimal communications route.

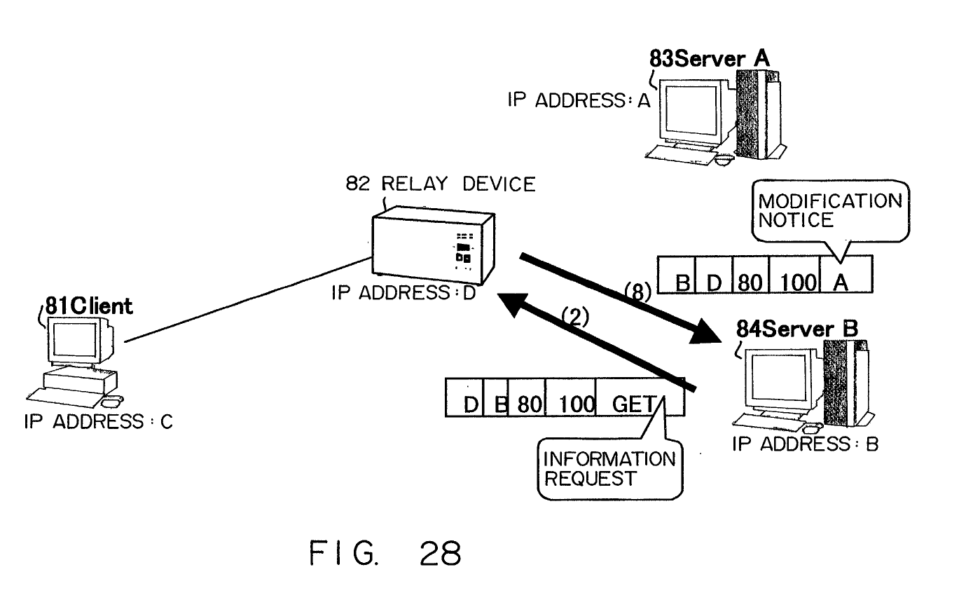

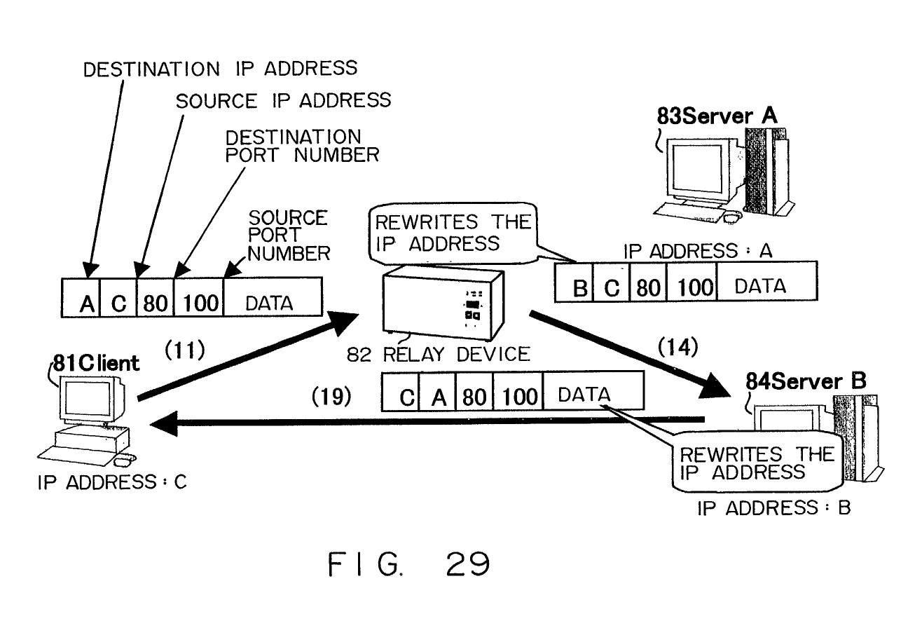

FIGS. 28 and 29 show the outline of the network in the fourth preferred embodiment of the present invention.

This network is composed of a client 81, a relay device 82, a server 83 (server A) and a server 84 (server B).

The relay device 82 has both an address modifying function and an information adding function, and notifies the server 84, of which the address has been modified, of information about address modification.

The server 84 has a function to request the relay device 82 to transmit address modification information and to modify the source address of response data based on the address modification information transmitted from the relay device 82 in response to the send request.

In the fourth preferred embodiment, the server 84 can modify a source address based on modification information generated by the relay device 82 without storing information for modifying the source address in advance.

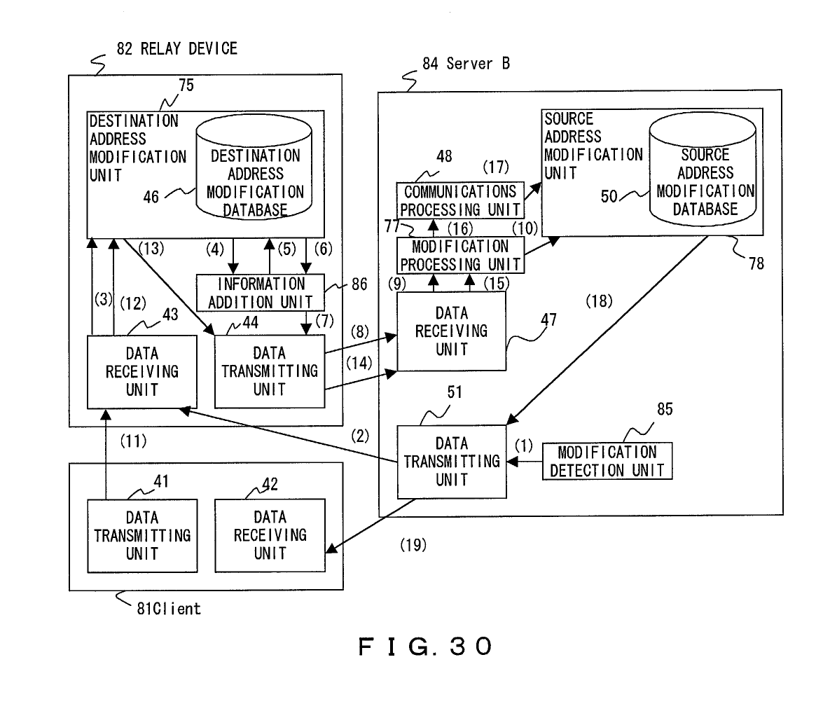

FIG. 30 shows the respective configurations of the client 81, relay device 82 and server 84 in the fourth preferred embodiment.

The client 81 comprises a data transmitting unit 41 transmitting data and a data receiving unit 42 receiving data.

The relay device 82 comprises a data receiving unit 43 receiving data, a data transmitting unit 44 transmitting data, a destination address modification unit 75 modifying the address of received communications data to the address registered in the destination address modification database 46, which is provided in the address modification database 46, and an information addition unit 86 generating address modification information.

The destination address modification unit 75 of the relay device 82 checks whether the address of received communications data are registered in the destination address modification database 46. If the address is registered, the unit 75 modifies the address to the address registered in the destination address modification database 46.

The information addition unit 86 generates communications data, including modification information indicating the original address of the communications data with the modified address.

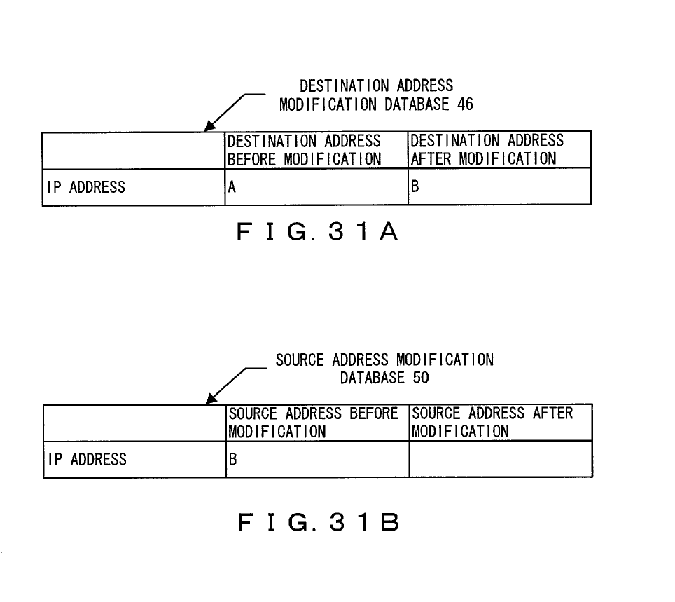

FIG. 31A shows an example of data registered in the destination address modification database 46. The destination address modification database 46 stores in advance both a destination IP address to be modified (in FIG. 31A, the IP address A of the server 83) and a destination IP address after modification (in FIG. 31A, the IP address A of the server 83).

The server 84 comprises a data receiving unit 47, a modification processing unit 77 updating the data of the source address modification database 50 based on address modification information from the relay device 82, a communications processing unit 48 performing a communications process requested by a source address, a source address modification unit 78 modifying the source address of transmission data, a source address modification database 50 storing both a source address to be modified and a source address after modification and a modification detection unit (request unit) 85 requesting the relay device 82 to transmit address modification information.

FIG. 31B shows an example of data registered in the source address modification database 50. In this case, a section of the source address modification database 50 for storing a source IP address after modification is blank. Then, the modification detection unit 85 requests the relay device 82 to transmit address modification information. On receipt of the modification information from the relay device 82, the source destination modification unit 78 writes the source IP address after modification in the source address modification database 50 based on the modification information.

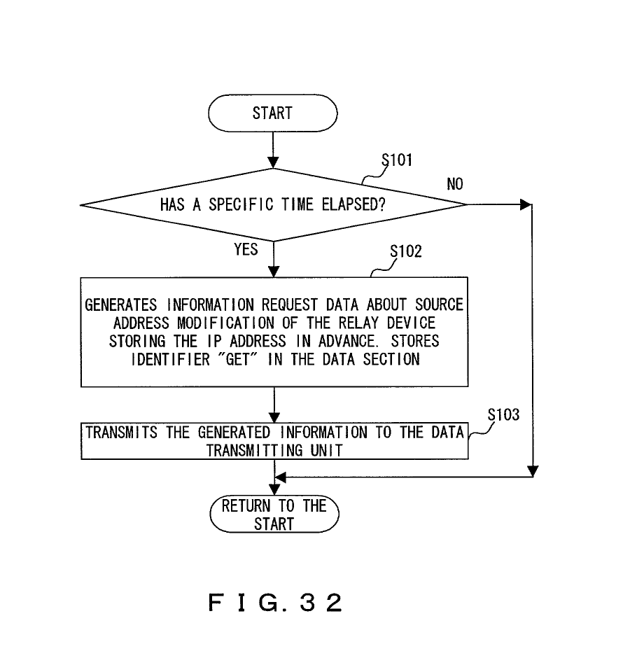

Next, the address modification process of the relay device 82, the modification information request process of the server 84 and the like are described with reference to the flowcharts shown in FIGS. 32 through 38.

First, the modification information request process of the modification detection unit 85 in the server 84 is described with reference to the flowchart shown in FIG. 30.

The modification detection unit 85 measures time using a timer and the like, and judges whether a specific amount of time has elapsed (step S101 of FIG. 32). If a specific amount of time has elapsed (Yes in step S101), the unit 85 generates data for requesting the relay device storing the IP address in advance to transmit information about source address modification and inserts an identifier “GET” indicating the fact in the data section (step S102). Then, the unit 85 outputs the generated send request data to the data transmitting unit 51 (step S103).

Thus, send request data requesting the relay device 82 storing the IP address to transmit information about source address modification are transmitted at specific time intervals. In response to this request, the relay device 82 transmits information about source address modification, which is described later.

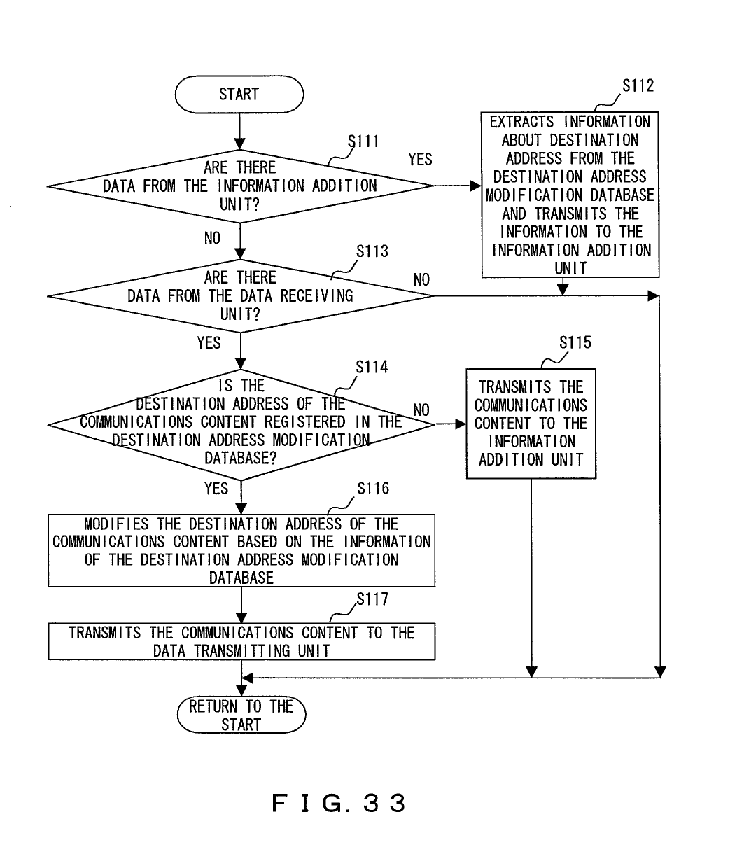

Next, the address modification process of the relay device 82 is described with reference to the flowchart shown in FIG. 33.

The destination address modification unit 75 of the relay device 82 judges whether there are data from the information addition unit 86 (step S111 of FIG. 33). If there are data (Yes in step S111), the flow proceeds to step S112. In step S112, the destination address modification unit 75 extracts information about address modification from the address modification database 46 and outputs the extracted information to the information addition unit 86.

If there are no data from the information addition unit 86 (No in step S111), the flow proceeds to step S113, and the destination address modification unit 75 further judges whether there are communications data from the data receiving unit 47. If there are communications data from the data receiving unit 47 (Yes in step S113), the destination address modification unit 75 further judges whether the address of the communications data are registered in the destination address modification database 46 (step S114).

If the address of the received communications data are not registered in the destination address modification database 46 (No in step S114), the flow proceeds to step S115, and the destination address modification unit 75 outputs the communications data to the information addition unit 86.

If the address of the communications data are registered in the destination address modification database 46 (Yes in step S114), the flow proceeds to step S116, and the destination address modification unit 75 modifies the address of the communications data to the address registered in the destination address modification database 46. Then, the destination address modification unit 75 outputs the communications data with the modified address to the data transmitting unit 44 (step S117).

Thus, when the information addition unit 86 requests the destination address modification unit 75 to transmit information about address modification, the destination address modification unit 75 extracts the information from the destination address modification database 46 and outputs the extracted information to the information addition unit 86.

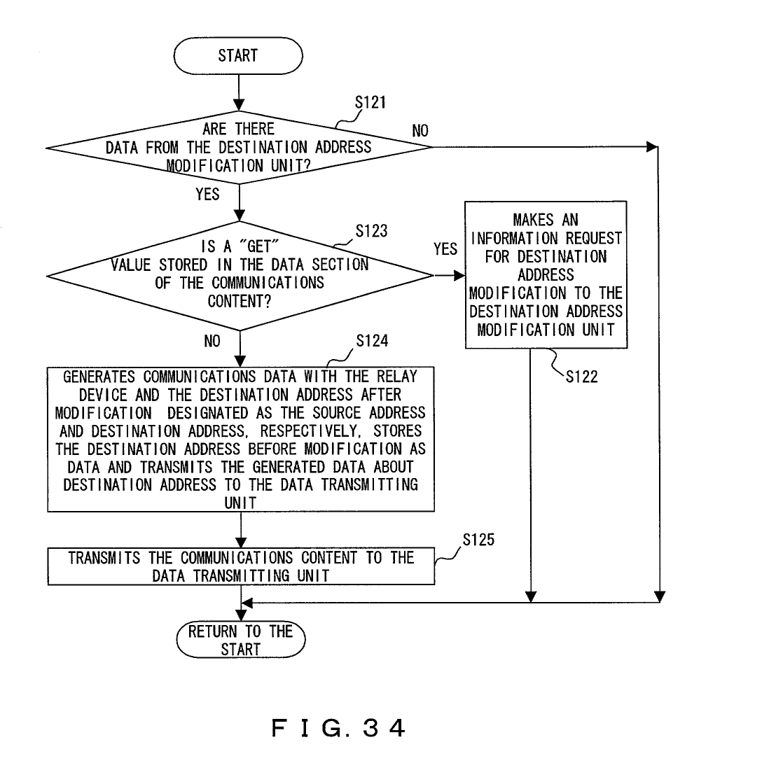

Next, the modification information generating process of the information addition unit 86 is described with reference to the flowchart shown in FIG. 34.

The information addition unit 86 judges whether there are data from the destination address modification unit 75 (step S121 of FIG. 34). If there are data from the destination address modification unit 75 (Yes in step S121), the flow proceeds to step S123, and the information addition unit 86 further judges whether identifier “GET” is stored in the data section of communications data.

If identifier “GET” is stored in the data section of the communications data (Yes in step S123), the flow proceeds to step S122, and the unit 86 requests the destination address modification unit 75 to transmit information about address modification.

Communications data storing identifier “GET” in the data section are send request data transmitted from the server 84 in order to obtain information about source address modification, as described earlier. On receipt of the communications data, including identifier “GET”, the information addition unit 86 requests the destination address modification unit 75 to transmit information about address modification. On receipt of the request for information about address modification from the information addition unit 86, the destination address modification unit 75 checks the address before modification in the destination address modification database 46 and outputs information indicating the address before modification to the information addition unit 86.

If identifier “GET” is not stored in the data section of the communications data outputted from the destination address modification unit 75 (No in step S123), the information addition unit 86 generates communications data storing the address before modification in the data section with the relay device 82 and the address after modification designated as the source and destination addresses, respectively, and outputs the communications data to the data transmitting unit 44 (step S124). Then, the unit 86 further outputs the communications data received from the client 81 to the data transmitting unit 44 (step S125).

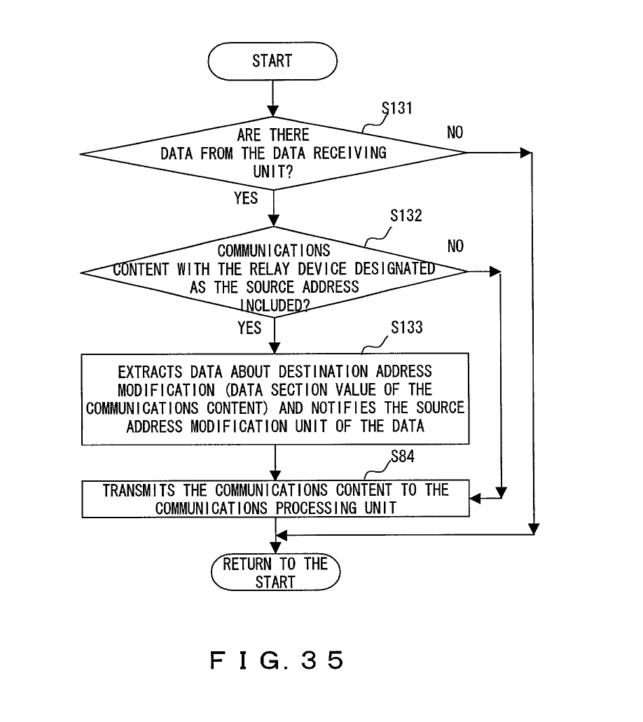

Next, the modification information obtaining process of the modification processing unit 77 in the server 84 is described with reference to the flowchart shown in FIG. 35.

First, the modification processing unit 77 judges whether there are data from the data receiving unit 47 (step S131 of FIG. 35). The modification processing unit 77 further judges whether the source address of the communications data received from the data receiving unit 47 is the relay device 82 (step S132).

If the source address is the relay device 82 (Yes in step S132), the modification processing unit 77 extracts data about address modification stored in the data section and notifies the source address modification unit 78 of the extracted modification information (step S133). The modification processing unit 77 also outputs communications data requested to be processed by the client 81 to the communications processing unit 48 (step S134).

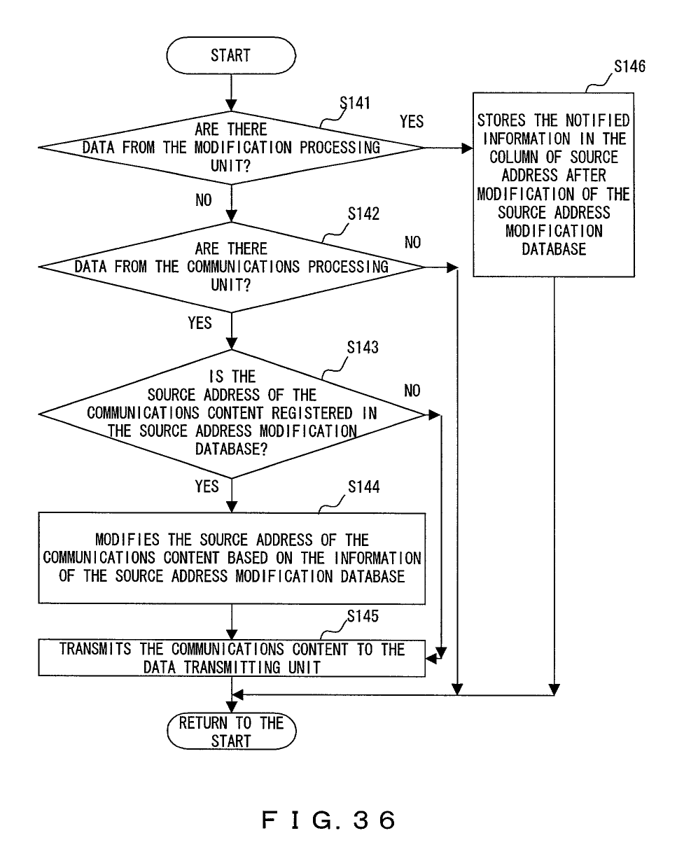

Next, the processes of the source address modification unit 78 of the server 84, both setting and modifying the source address after modification and modifying the source address of the source address modification database 50 based on address modification information that is transmitted from the relay device 82 are described with reference to the flowchart shown in FIG. 36.

First, the source address modification unit 78 judges whether there is any notice from the modification processing unit 77 (step S141 of FIG. 36). If there is notice from the modification processing unit 77 (Yes in step S141), specifically if the modification detection unit 85 requests the relay device 82 to transmit information about address modification and the relay device 82 transmits the information, the flow proceeds to step S146, and the source address modification unit 78 sets the information as the source address after modification of the source address modification database 50. Thus, the server 84 can obtain information about a source address to be modified based on the modification information transmitted from the relay device 82 without in advance storing the information about a source address to be modified.

If there is no notice from the modification processing unit 77 (No in step S141), the flow proceeds to step S142, and the source address modification unit 78 further judges whether there are communications data from the communications processing unit 48 (step S142) If there are communications data from the communications processing unit 48 (Yes in step S142), the source address modification unit 78 further judges whether the source address of the communications data is registered in the source address modification database 50 (step S143).

If the source address is registered in the source address modification database 50 (Yes in step S143), the unit 78 modifies the source address of the communications data based on data registered in the source address modification database 50 (step S144). Furthermore, the unit 78 outputs the modified communications data to the data transmitting unit 51.

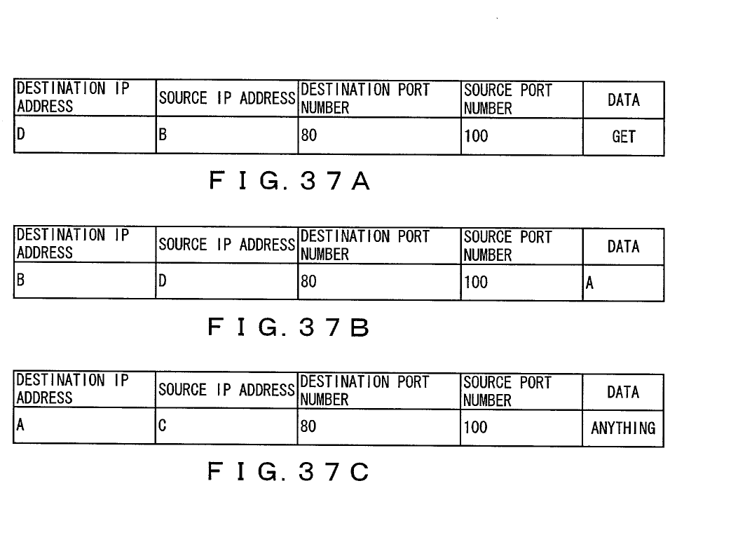

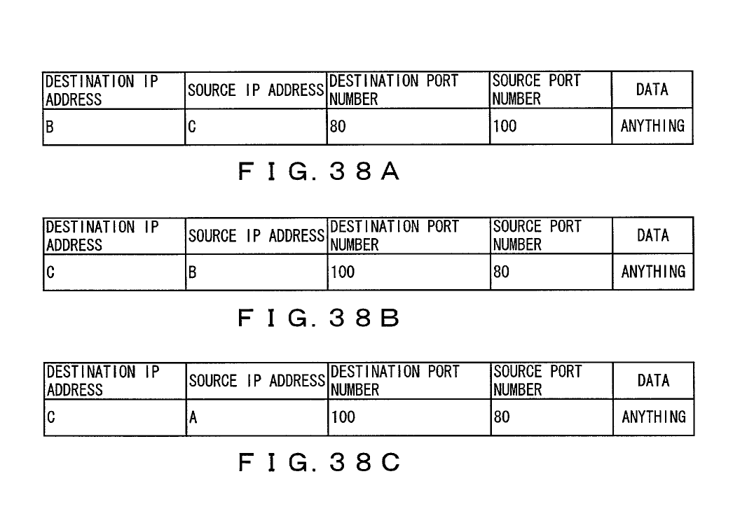

Next, the process operation of the fourth preferred embodiment of the present invention is described using the communications data shown in FIGS. 37A through 37C and FIGS. 38A through 38C with reference to FIGS. 28 through 31.

FIGS. 37A through 37C show communications data corresponding to the network configuration shown in FIG. 28.

When detecting the expiration of a specific amount of time, the modification detection unit 85 of the server 84 makes a request for transmitting information about address modification ((1) of FIG. 30). In this case, as shown in FIG. 37A, send request communications data generated by the modification detection unit 85 stores the IP address D of the relay device 82 and the IP address B of the server 34 as the destination and source IP addresses, respectively, and further stores identifier “GET” in the data section.

On receipt of the send request for information about source address modification from the server 84 ((2) of FIG. 30), the data receiving unit 43 of the relay device 82 outputs the send request to the destination address modification unit 75. The destination address modification unit 75 outputs the send request to the information addition unit 86 ((4) of FIG. 30).

If the communications data received from the destination address modification unit 75 includes identifier “GET”, the information addition unit 86 requests the destination address modification unit 75 to transmit information about address modification ((5) of FIG. 30) and obtains the address modification information ((6) of FIG. 30). Then, the unit 86 generates communications data, including the obtained address modification information and outputs the information to the data transmitting unit 44 ((7) of FIG. 30). As shown in FIG. 37B, the communications data generated at this time contain B and the IP address D of the relay device 82 as the destination and source IP addresses, respectively, and further contain destination IP address A before modification in the data section.

The data receiving unit 47 of the server 84 receives communications data from the relay device 82 ((8) of FIG. 30) and outputs the received communications data to the modification processing unit 77 ((9) of FIG. 30). The modification processing unit 77 extracts the address modification information stored in the data section of the received communications data and notifies the source address modification unit 78 of the information ((10) of FIG. 30).

The source address modification unit 78 sets the source address after modification of the source address modification database 50 based on the modification information notified by the modification processing unit 77. Specifically, the unit 78 sets the IP address A of the server 83 designated by the modification information as the source address after modification of the source address modification database 50, which is blank in FIG. 31B.

Then, when the client 81 transmits communications data as shown in FIG. 37C to the server A ((11) of FIGS. 29 and 30), as in the third preferred embodiment described earlier, the address of the communications data is modified by the destination address modification unit 75 of the relay device 82 and is outputted to the data transmitting unit 41 ((13) of FIG. 30).

FIG. 37D shows an example of the communications data transmitted from the relay device 82 to the server 84, and the destination IP address is modified from the IP address A of the server 83 to the IP address B of the server 84.

The communications data are received by the data receiving unit 47 of the server 84 ((14) of FIG. 30), and are outputted from the data receiving unit 47 to the modification processing unit 77 ((15) of FIG. 30). The data are further outputted from the modification processing unit 77 to the communications processing unit 48 ((16) of FIG. 30). Then, a process designated by the communications data is performed by the communications processing unit 77, and response data are generated in order to return the process result and are outputted to the source address modification unit 78 ((17) of FIG. 30).

FIG. 38A shows an example of the response data generated by the communications processing unit 48, and the IP address C of the client 81 and the IP address B of the server 84 are set as the destination and source IP addresses, respectively.

The source address modification unit 78 judges whether the source address should be modified, based on both the communications content (for example, source address) and data registered in the source address modification database 50, and outputs the modified or unmodified communications data to the data transmitting unit 51 ((18) of FIG. 30). Then, the data transmitting unit 51 transmits the communications data to a network ((19) of FIG. 30).

According to the fourth preferred embodiment described above, the server 84 transmits a send request for information about source address modification to the relay device 82. The data indicating the source address after modification of the source address modification database 50 can be set based on modification information transmitted from the relay device 82 in response to the request. Therefore, the server 84 can modify the source address of response data by obtaining the information from the relay device 82 without storing information about the source address of the communications data.

If there are a plurality of relay devices 82 and a plurality of servers 84, one relay device 82 can also manage information about source address modification. Thus, the management of modification information becomes easy, since one relay device can manage full information about source address modification.

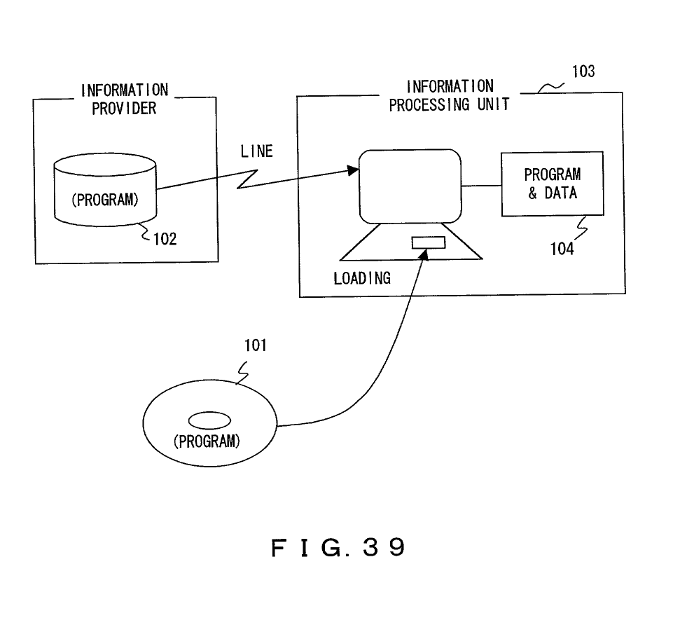

FIG. 39 shows the case where a communications control program for implementing the source address modifying function of the communications device described above is stored in a portable storage medium 101, such as a CD-ROM, a floppy disk or a storage device possessed by a program provider, is loaded into a user's information processing device 103.

If the communications control program is stored in a portable storage medium 101, such as a CD-ROM, a floppy disk and the like, the program is read by inserting the portable storage medium 101 in the driving device of the information processing device 102 and is executed by storing the read program in a storage device 104, such as a RAM, a hard disk and the like. If a program provider provides the program through a communications line, the program stored in the storage device 102, a memory or the like of the program provider is received by the information processing device 103 through a communications line and is executed by storing the received program in the storage device 104, such as a RAM, a hard disk or the like. Alternatively, the program stored in the portable storage medium 101 can have a part of the functions of the program described above in the preferred embodiment.

Although in the preferred embodiments described above, the server 34, 64 or the like to which communications data with the server 33, 63 or the like designated as a destination address are transferred has a function to modify the source address of response data, the server 34, 64 or the like to which communications data are transferred does not necessarily need to have the function to modify the source address. Alternatively, instead of the server 34, 64 or the like, a router or the like connected to the network can have those functions and can modify the source address of response data outputted from the server 34, 64 or the like.

Alternatively, instead of providing an address modification device separately from a communications device, such as the client 31, 61 or the like, the client 31, 61 or the like can have the function to modify an address.

The present invention is applicable not only to communications between a client and a server, but also to communications between servers.

According to the present invention, a communications device on the receiving side can transmit response data to a communications device on the originating side without going through an address modification device. Therefore, even if a route between the communications device on the receiving side and the communications device on the originating side through the address modification device includes a redundant route, data can be transmitted along an optimal route without going through the address modification device.

What is claimed is:

1. A communications device connected to a network with an address modification device, comprising:
a transmitting and receiving unit transmitting and receiving communications data; and
a source address modification unit modifying a source address of data in response to communications data with an address modified by the address modification device, to an original destination address of the communications data.

2. A communications device connected to a network with an address modification device, comprising:
a transmitting and receiving unit transmitting and receiving communications data;
an acquisition unit obtaining address modification information transmitted from the address modification device; and
a source address modification unit modifying a source address of data in response to the communications data with an address modified by the address modification device based on the address modification information.

3. A communications device connected to a network with an address modification device, comprising:
a transmitting and receiving unit transmitting and receiving communications data;
a request unit requesting the address modification device to transmit address modification information of the communications data; and
a source address modification unit modifying a source address of response data based on modification information transmitted from the address modification device.

4. The communications device according to claim 1, further comprising:
a plurality of communications processing units; and
a sorting unit assigning a process to the relevant communications processing unit of the plurality of communications processing units based on identification information added to the communications data.

5. The communications device according to claim 4, wherein said sorting unit assigns a process to the relevant communications processing unit of the plurality of communications processing units based on information designated by a communications port included in the communications data.

6. An address modification device, comprising:
a transmitting and receiving unit transmitting and receiving communications data;
a destination address modification unit modifying a destination address of the communications data transmitted from a communications device; and
a modification information generating unit enabling to transmit address modification information to a communications device with a modified address.

7. An address modification device, comprising:
a transmitting and receiving unit transmitting and receiving communications data;
a destination address modification unit modifying a destination address of transmission data transmitted from a communications device; and
a modification information generating unit enabling to transmit address modification information of the communications data to the relevant communications device when receiving a send request for the address modification information.

8. The address modification device according to claim 6, wherein
said destination address modification unit modifies the destination address of the communications data transmitted from a communications device connected to a network and
said modification information generating unit transmits information indicating the destination address before modification as modification information.

9. The address modification device according to claim 6, wherein
said modification information generating unit adds information indicating the destination address before modification to a data section of the communications data and transmits the data.

10. A communications method in a network comprised of an address modification device and a plurality of communications devices, comprising;
modifying a source address of response data to transmission data with an address modified by the address modification device to an original destination address of the transmission data and transmitting the response data.

11. A communications method in a network comprised of an address modification device and a plurality of communications devices, comprising:
requesting the address modification device to transmit address modification information; and
receiving the address modification information from the address modification device and modifying a source address of data in response to communications data with an address modified by the address modification device base on the address modification information.

12. A communications method in a network comprised of an address modification device and a plurality of communications devices, comprising:
transmitting and receiving communications data and obtaining address modification information transmitted from the address modification device; and
modifying a source address of response data to the communications data with an address modified by the address modification device based on the modification information and transmitting the response data.

13. A computer-readable communications control program performing control of communications in a network comprised of an address modification device and a plurality of communications devices to enable a computer to implement functions, the functions comprising:
transmitting and receiving communications data; and
modifying a source address of response data to communications data with an address modified by the address modification device and transmitting the data.

14. A computer-readable communications control program for performing control of communications in a network comprised of an address modification device and a plurality of communications devices to enable a computer to implement functions, the functions comprising:
transmitting and receiving communications data;
requesting the address modification device to transmit address modification information; and
modifying a source address of response data based on modification information transmitted from the address modification device.

15. A computer-readable storage medium which stores a program for enabling a computer to implement functions, the functions comprising:
transmitting and receiving communications data; and
modifying a source address of response data to communications data with an address modified by the address modification device and transmitting the response data.

16. A communications system in which an address modification device for modifying an address of communications data received from another communications device and a plurality of communications devices for transmitting and receiving data in response to the communications data with a modified address are connected through a network, comprising:
an address modification device, further comprising:
transmitting and receiving communications data; and
a destination address modification unit modifying an address of the communications data, and
each of a plurality of communications devices, further comprising:
transmitting and receiving communications data; and
a source address modification unit modifying a source address of response data to the communications data with an address modified by the address modification device to an original destination address of the communications data.

17. A communications system in which an address modification device for modifying an address of communications data received from another communications device and a plurality of communications devices for transmitting and receiving data in response to the communications data with a modified address are connected through a network, comprising:
address modification device, comprising:
a transmitting and receiving unit transmitting and receiving communications data;
a destination address modification unit modifying an address of the communications data; and
a modification information generating unit generating and transmitting address modification information, and
each of a plurality of communications devices, comprising:
a transmitting and receiving unit transmitting and receiving communications data;
an acquisition unit obtaining modification information transmitted from the address modification device; and
a source address modification unit modifying a source address of response data to the communications data with an address modified by the address modification device based on the address modification information.
